(19) United States
(12) Patent Application Publication
(10) Pub. No.: US 2004/0025612 A1
(43) Pub. Date: Feb. 12, 2004

(54) Gearbox comprising a clutch and a method for operating a clutch

(76) Inventors: Gerd Ahnert, Sasbach (DE); Burkhard Pollak, Buhl-Weitenung (DE); Alexander Renfer, Buhl (DE); Matthias Schneider, Kilstett (FR); Bard Vestgard, Lier (NO)

Correspondence Address: Alfred J. Mangels, 4729 Cornell Road, Cincinnati, OH, 45241-2433, US

(21) Appl. No.: 10/298,141

(22) Filed: Nov. 16, 2002

Related U.S. Application Data
(63) Continuation of application No. PCT/DE01/01749, filed on May 7, 2001.

(30) Foreign Application Priority Data
May 17, 2000 (DE) 100 24 188.3
May 25, 2000 (DE) 100 25 878.6

(51) Int. Cl. F16H 3/08

(52) U.S. Cl. 74/329; 74/330; 74/331

(57) ABSTRACT

A transmission including a drive shaft that can be connected with a drive motor. The transmission has at least two input shafts that are part of respective separate, parallel transmission paths that each include a plurality of gear trains defining respective transmission ratios. At least one clutch is provided to enable a transmission step to be shifted with reduced tractive force interruption during a shift between different gears.

The invention relates to a transmission with an input shaft connectable with a drive motor, and output shaft, and shafts lying therebetween, through which a first and a second parallel transmission path is formed, whereby those shafts carry gears that form transmission ratio steps, in which in each case a first gear is non-rotatably connected with a first shaft as a speed change gear, and a second gear in engagement with the first as an idler gear is rotatably arranged on a second shaft, and in which the idler gear is connectable on the shaft on which it is carried by means of at least one clutch.

The designations of the individual transmission shafts, such as input shaft, transmission input or transmission output shaft, designate functions within the scope of the present invention, whereby one shaft can also fulfill several functions, and can consequently be designated in different ways. For example, an input shaft can at the same time be a transmission input shaft, or a transmission input shaft can simultaneously fulfill the function of a transmission output shaft. Different designations of one of those shafts do not necessarily designate another shaft, but only another function of the shaft in question.

Within the meaning of the present application, a tractive force-reducing shift is to be understood as a shift from one gear ratio condition into another gear ratio condition, whereby the path of force in connection with a flow of power from the drive motor in the direction of the driven vehicle wheels, and/or the reverse, is interrupted with respect to amount, and/or is temporally less strong owing to the shift process, in comparison with a transmission in which the flow of force between the drive motor and the driven vehicle wheels is interrupted during the shift process. Ideally, a shift takes place without interrupting the flow of power, or at least with only minimal power flow interruption.

Furthermore, in the present case such a tractive force interruption reduction is to be understood by the term load shift. A clutch, by means of which such a load-shift can be carried out, is designated as a load-shifting clutch, whereby this designation is not to be understood as exclusive. A clutch so designated can if necessary be used even in starting procedures. Correspondingly, a clutch designated in this application as a starting clutch can if necessary be used for load-shifting, even if its task is primarily the separation of starting transmission ratio steps from the input shaft. If only one clutch is present in an embodiment, that consequently is equally used as a starting as well as a load-shifting clutch, that clutch can be designated as a starting as well as a load-shifting clutch.

So-called load-shifting transmissions have already become known in that two parallel transmission paths are present.

Such transmissions can be constructed such that each transmission path is separable from the drive motor by a clutch, and in accordance with the sequence with respect to their transmission ratios, transmission ratio steps following one another are in each case associated with different clutches. In this way, a change in transmission ratio with reduced tractive force interruption is possible by operation of the two clutches in the switchover change, whereby the input torque changes from one transmission path to the other in a shift between transmission ratio steps that have reduced tractive force interruption in relation to their transmission ratio.

Moreover such transmissions can be constructed such that, in accordance with the sequence with respect to their transmission ratios, successive transmission ratio steps are associated with the same clutch, and by a shift process between those transmission ratio steps a driving torque is transmitted through the other transmission path to the driving wheels during the shifting process.

Such transmissions require a great deal of space and encompass a large number of components that is also very disadvantageous, especially with regard to costs, installation, and weight. For example, an actuator with shift and selection actuators is often necessary in each transmission path, and/or two friction clutches are present, which if necessary must be actuated independently of one another. Furthermore, often a large number of synchronization devices are needed for synchronization of the transmission ratio steps.

Therefore an object of the invention is to provide a transmission that can be manufactured economically, that has a small number of components, and that requires only a small amount of space, that is as well simpler to install, and that has a lower weight. Furthermore, driving comfort should be improved with the transmission and simpler operation should be achieved for the driver as well.

One aspect of that object is accomplished in accordance with the invention in that the first transmission path is associated with at least two transmission ratio steps that are successive with respect to their transmission ratios, and all transmission ratio steps are shiftable with reduced tractive force interruption. It is especially advantageous if the transmission ratio steps, especially in the acceleration mode of the drive motor, can be upshifted with reduced tractive force interruption. Furthermore, it is very much of an advantage if the transmission ratio steps, especially in the deceleration mode of the drive motor, can also be shifted back with reduced tractive force interruption.

In accordance with a preferred embodiment of the invention, one transmission path is associated with a clutch that is basically used as a starting clutch, and another transmission path is associated with a clutch that is used as a load-shifting clutch. Each of the transmission ratio steps included in those transmission paths is consequently separable from the input shaft.

In this embodiment, the transmission path associated with the starting clutch includes at least two successive transmission ratio steps with respect to their transmission ratios. It especially includes a group of successive transmission ratio steps, with respect to their transmission ratios, that are shiftable with reduced tractive force interruption.

In this embodiment, the starting clutch is basically used for starting processes, but if necessary, also in passing change with the load-shifting clutch for tractive force interruption-reducing shifting. The load-shifting clutch is used for tractive-force-interruption-reducing shifting of successive transmission ratio steps, with regard to their transmission ratios, in the transmission path associated with the starting clutch, and operates as well in gradual changes with the starting clutch for tractive-force-interruption-reducing shifting of transmission ratio steps associated with the load-shifting clutch and transmission ratio steps associated with the starting clutch. In a further embodiment, it can also be appropriate to use the starting clutch for load-shifts from the transmission path of transmission ratio steps associated with the load-shifting clutch.

In the present exemplary embodiment of the invention, the transmission path associated with the load-shifting clutch, particularly advantageously for tractive-force-interruption-reduced upshifting in acceleration of the drive motor, includes a transmission ratio step with a lower transmission ratio than that of the transmission ratio step to be shifted for reduced tractive force interruption. The load-shifting clutch is connectable at that transmission ratio step. Appropriately, that transmission ratio step is that with the lowest transmission ratio. In another exemplary embodiment of the invention, it can nonetheless also be advantageous if the transmission ratio step connected or connectable with the load-shifting clutch has a lower transmission ratio than that of the transmission ratio step to be shifted for reduced tractive force interruption, but nevertheless not the lowest transmission ratio. Appropriately, the difference between those two transmission ratios is not too great, since then the tractive force intrusion is small.

In a preferred embodiment, the transmission path associated with the load-shifting clutch, for tractive-force-interruption-reduced downshifting in deceleration of the drive motor, includes a transmission ratio step with a higher transmission ratio than that of the transmission ratio step to be shifted for reduced tractive force interruption. The load-shifting clutch is connectable at that transmission ratio step. Appropriately, that transmission ratio step is that with the highest transmission ratio. In another exemplary embodiment of the invention, it can nonetheless also be advantageous if the transmission ratio step connected or connectable with the load-shifting clutch has a higher transmission ratio than the transmission ratio step to be shifted for reduced tractive force interruption, but not the highest transmission ratio. Appropriately, the difference between those two transmission ratios is not too great, as then the tractive force intrusion is small.

In the present exemplary embodiment, transmission ratio steps of transmission paths can advantageously also be shifted with reduced tractive force interruption by an activation of the clutches associated with it in the switchover change.

It is furthermore very advantageous if the transmission path associated with the starting clutch includes transmission ratio steps that are used for starting up. Those are particularly the first gear and the reverse gear, if necessary, for example for starting with reduced torque on a slippery roadway. In one embodiment of the invention, it can also be appropriate if the transmission path associated with the load-shifting clutch includes transmission ratio steps that are used for starting up.

In a further, especially advantageous embodiment of the invention, a clutch usable as a load-shifting clutch as well as a starting clutch is associated with a transmission path, whereby another transmission path is not associated with a clutch. A particular advantage lies in the fact that, in this embodiment, only one clutch is needed.

Appropriately the transmission path associated with no clutch includes at least two successive transmission ratio steps that succeed one another with respect to their transmission ratios. It particularly includes a group of successive transmission ratio steps that succeed one another with respect to their transmission ratios that are shiftable with reduced tractive force interruption.

It is especially advantageous if, in particular for tractive-force-interruption-reduced upshifting in acceleration of the drive motor, the transmission path associated with the clutch has a transmission ratio step with a lower transmission ratio than the transmission ratio step to be shifted to for reduced tractive force interruption. The clutch is connectable with that transmission ratio step. Appropriately, that transmission ratio step is that with the lowest transmission ratio. In another exemplary embodiment of the invention, it can nevertheless also be advantageous if the transmission ratio step connected or connectable with the clutch has a lower transmission ratio than that of the transmission ratio step to be shifted to for reduced tractive force interruption, however not the lowest transmission ratio. Appropriately, the difference between those two transmission ratios is not too large, since then the tractive force intrusion is small.

It is moreover advantageous for shifting with reduced tractive force interruption in deceleration of the drive motor, especially for downshifting with reduced tractive force interruption during deceleration of the drive motor, the transmission path associated with the clutch has a transmission ratio step with a higher transmission ratio than that of the transmission ratio step to be shifted to for reduced tractive force interruption. The clutch is connectable with that transmission ratio step. Appropriately, that transmission ratio step is that with the highest transmission ratio. In another exemplary embodiment of the invention, it can nonetheless also be advantageous if the transmission ratio step connected or connectable with the clutch has a higher transmission ratio than the transmission ratio step to be shifted to for reduced tractive force interruption, but not the highest transmission ratio. Appropriately the difference between those two transmission ratios is not too great, as then the tractive force intrusion is small.

It is furthermore very advantageous if the transmission path associated with the clutch includes transmission ratio steps that are used for starting up. Those are especially the first gear and the reverse gear, and if need be second gear as well, for example for starting with reduced torque on a slippery roadway.

In an especially preferred embodiment of the invention, a transmission path includes at least one transmission ratio step that has approximately the same transmission ratio as a transmission ratio step included in another transmission path. There is, for example, at least one transmission ratio step with identical transmission ratio in each of the transmission paths.

In an especially preferred configuration, at least one transmission ratio step is selectively associatable with one or another transmission path. A transmission ratio step in the transmission at the end region of the two transmission input shafts, for example an end region of a hollow shaft surrounding a transmission shaft, is appropriately allocated for that purpose, and is selectively connectable with the hollow shaft or with the transmission shaft surrounded by it by means of a sliding sleeve, for example.

It is especially of advantage if the transmission ratio step with the highest transmission ratio is present in one transmission path as well as in another transmission path, or is associatable with either one transmission path or the other transmission path.

In another exemplary embodiment, it is advantageous for the transmission ratio step with the highest transmission ratio to be present in one transmission path as well as in another transmission path, or is associatable with either one transmission path or the other transmission path, and at least one further transmission ratio step with a lower transmission ratio is present in one transmission path as well as in another transmission path.

In accordance with a further conception of the invention, it is particularly advantageous if, in a transmission with an input shaft connectable with a drive motor, two coaxially arranged transmission input shafts, one inside the other, a transmission output shaft and at least one clutch, such as a friction clutch, whereby in the transmission at least first and second parallel transmission paths are provided. The first transmission path includes a plurality of successive transmission ratio steps that are shiftable with reduced tractive force, and that succeed one another with respect to their transmission ratios, and associated with a startup coupling or a combined starting/load-shifting clutch. The second transmission path is associated with at least one load-shifting clutch or a combined starting/load-shifting clutch. The first transmission path is formed by the outer and the second transmission path by the inner of the two coaxial transmission shafts that are arranged one inside the other.

In a preferred configuration of the invention, starting and load-shifting clutches are each formed by a separate clutch disk, whereby the starting clutch lies, for example, in the power flow of the first transmission path and the load-shifting clutch lies in the power flow of the second transmission path, which corresponds to a parallel arrangement. In another exemplary embodiment, it can also be appropriate if the starting clutch lies in the power flow of the first and the second transmission paths, and the load-shifting clutch lies in the power flow of the second transmission path, which corresponds to a serial arrangement.

In a further embodiment of the concept of the invention, starting and load-shifting clutches are formed with a common clutch disk, whereby appropriately the clutch is selectively connectable with the first or with the second transmission path, and the first transmission path can be connected with the drive motor through the clutch or directly.

An additional concept of the invention concerns a method for operating a clutch, especially for determining the contact point of the load-shifting clutch of a load-shiftable transmission that has at least two parallel transmission paths.

During engagement (analogously during disengagement) of a clutch, the transition between minimum and maximum torque transfer is progressive, so that within the meaning of the present invention, by contact point is to be understood a position of the clutch where a very small but measurable torque is transmitted. The contact point advantageously lies in the lowermost region of the rising characteristic curve of the torque transmitted by engaging the clutch. In the present exemplary embodiment, the contact point lies in the region of 0 to 20 Nm, preferably at 2 Nm.

Advantageously for determining the contact point of the load-shifting clutch in the transmission path associated with the load-shifting clutch, the transfer of a torque between the drive motor and the load-shifting clutch, at least up to the value of the measuring torque, is possible without loss or interruption. Furthermore, the transfer of a torque between the load-shifting clutch and the motor vehicle, at least up to the value of the measuring torque, is possible without loss or interruption in the transmission path associated with the load-shifting clutch. In doing so, the load-shifting clutch is here bypassed. It is assured that the complete torque supplied by the drive motor is applied to the load-shifting clutch, at least up to the value of the measuring torque, and is supported by the driven vehicle wheels upon engagement of the same.

Appropriately, a transmission ratio step is set in the transmission path associated with the load-shifting clutch for ascertaining the contact point, and a vehicle brake associated with the driven vehicle wheels is operated as well. Furthermore, no transmission ratio step is set in the first transmission path. In another exemplary embodiment of the invention, the torque can also be supported by the inertia of the vehicle mass instead of by the vehicle brakes, and in that case the vehicle is on a level surface.

If a starting clutch is associated with the transmission path of the load-shifting clutch, then that starting clutch is engaged at least to the extent that a torque greater than the contact torque is transmittable, so that at least up to the value of the contact torque the complete torque supplied by the drive motor is applied to the load-shifting clutch.

Appropriately, the determination of the contact point of the load-shifting clutch, in which the load-shifting clutch is engaged slowly, until a torque corresponding to the contact torque is transmitted, and thereby the contact point is achieved.

Advantageously the contact point is determined on the basis of a decreasing rotational speed of the drive motor and/or a rising rotational speed in the region between the load-shifting clutch and the motor vehicle wheel, and/or on the basis of a rising torque in the region between the drive motor and the load-shifting clutch, and/or between the load-shifting clutch and the vehicle wheel.

If a rising and/or falling rotational speed is relied upon to determine the contact point, the motor vehicle brake is advantageously not operated, and the increasing torque during slow engagement of the load-shifting clutch is supported against the inertia of the motor vehicle mass. The vehicle here is advantageously situated on a level surface.

A contact point determined in this manner, by way of example, is particularly advantageously associated with a prevailing clutch position, and the clutch position and/or the site of the clutch drive associated with that position, and/or the position of a suitable reference point of the clutch activation apparatus, which if need be also includes a kinematic chain, is stored.

The concept of clutch position presently designates a certain distance of the plates between which the clutch disks with their friction linings are grippable through the relative axial displacement toward one another for the purpose of transmitting a torque using friction.

Embodiments of the invention will be further explained below on the basis of the drawings, wherein:

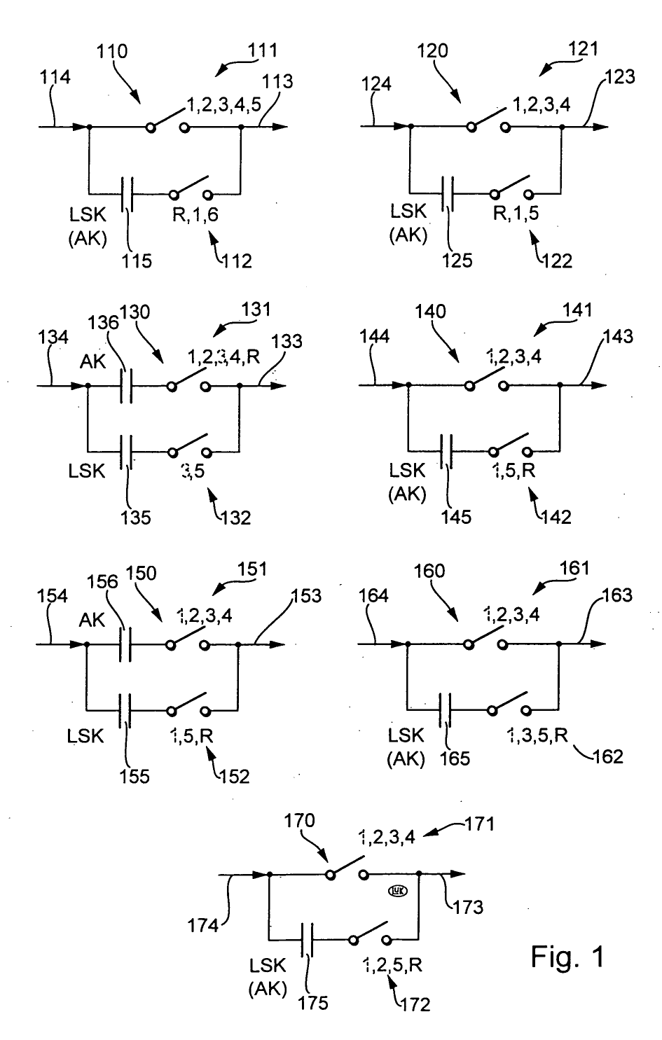

FIG. 1 multiple connection diagrams for arrangement of clutches or groups of transmission ratio step relative to two transmission paths,

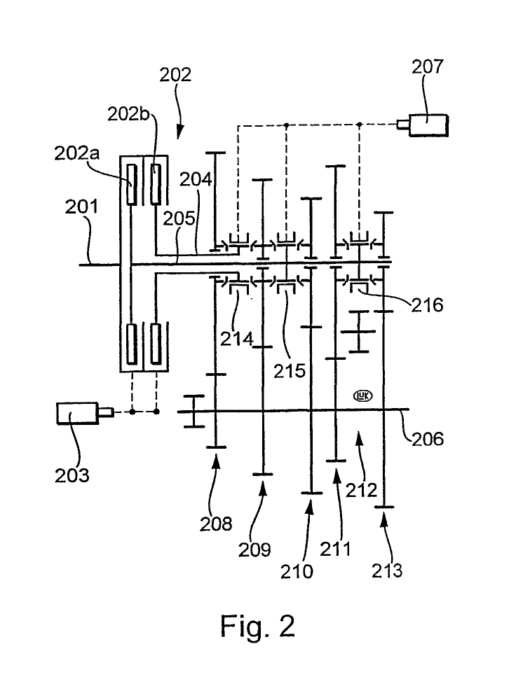

FIG. 2 an arrangement of an exemplary embodiment with starting and load-shifting clutches in the third or fifth gear,

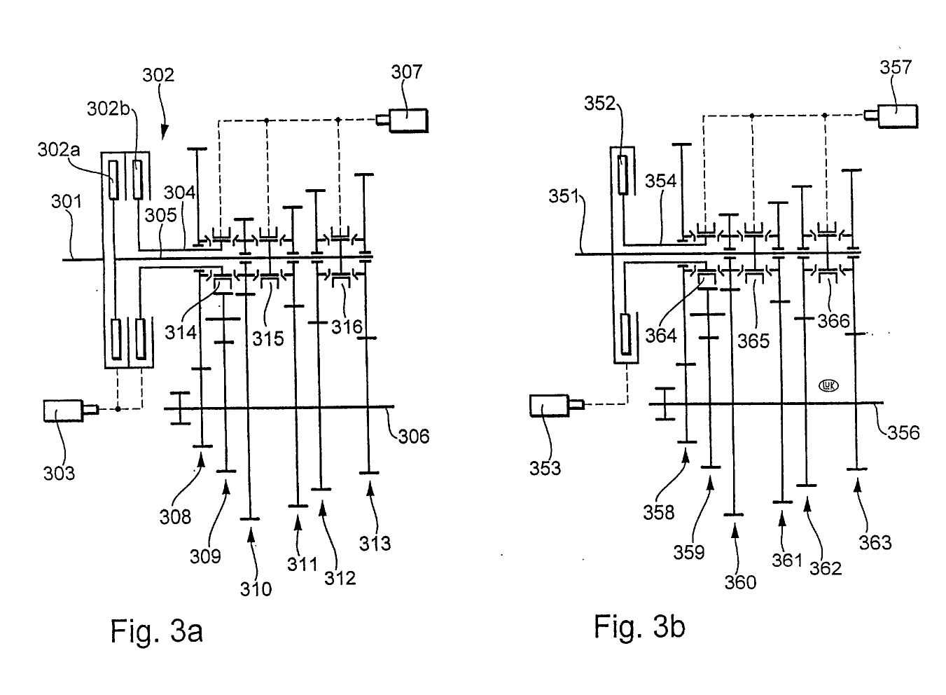

FIG. 3a an arrangement of an exemplary embodiment with a stop clutch and a load-shifting clutch in the first, fifth, or reverse gear,

FIG. 3b an arrangement of an exemplary embodiment with a clutch usable as a starting and/or a load-shifting clutch in the first, fifth, or reverse gear,

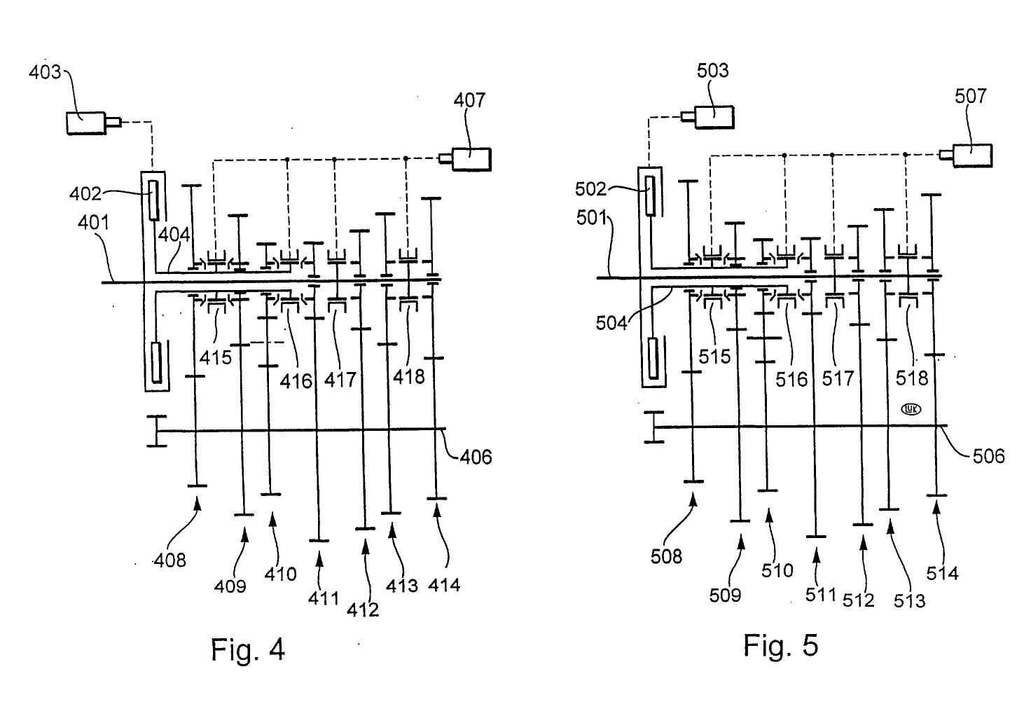

FIG. 4 an arrangement of an exemplary embodiment with a clutch usable with the first, third, fifth, or reverse gear,

FIG. 5 an arrangement of an exemplary embodiment with a clutch connectable with gears 1, 2, 5, or reverse,

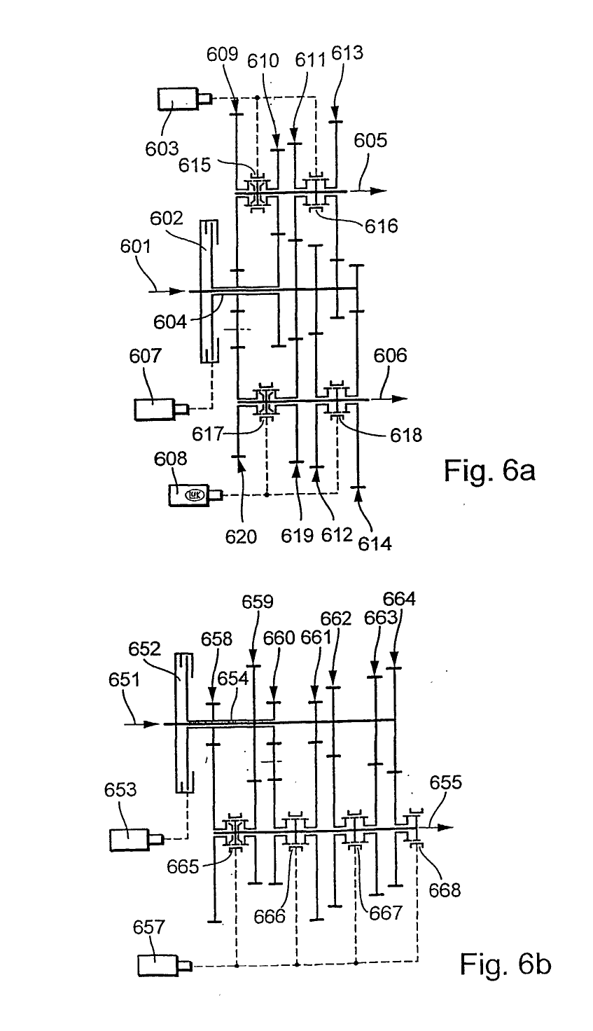

FIG. 6a an arrangement of an exemplary embodiment of a clutch used as a starting and a load-shifting clutch with a 6-speed transmission,

FIG. 6b a 5-speed transmission with a clutch usable as a starting and a load-shifting clutch,

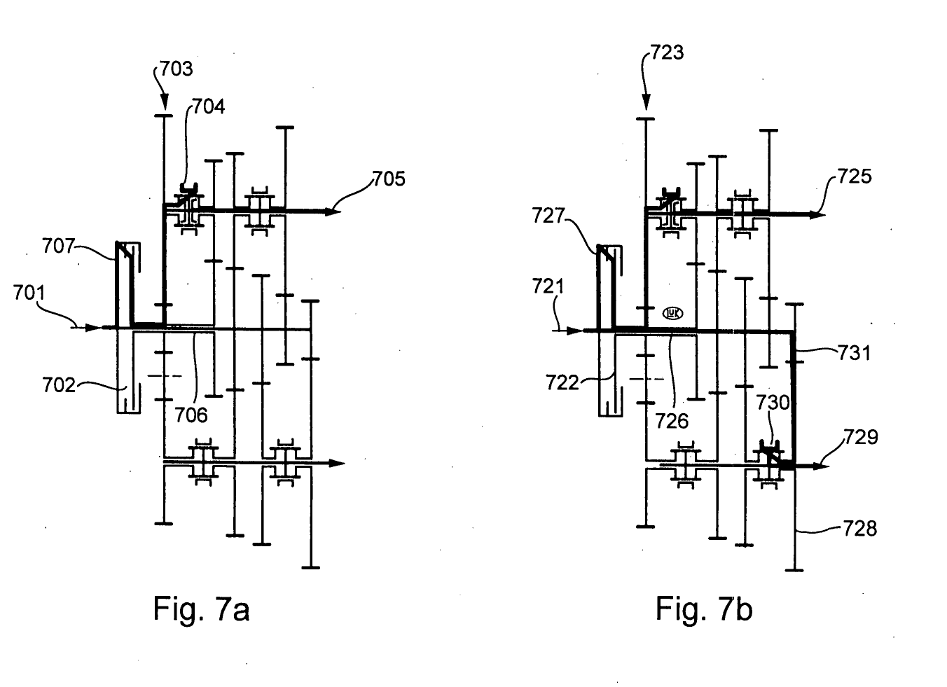

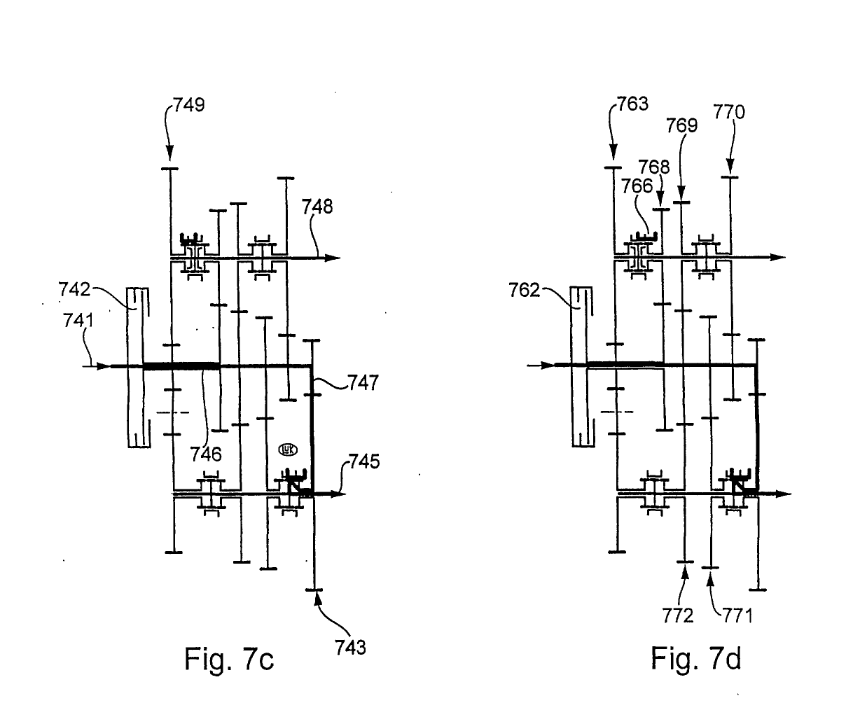

FIG. 7a torque flow during the startup process,

FIG. 7b the transition of torque flow in the transmission path associated with no clutch,

FIG. 7c torque flow exclusively over the transmission path associated with no clutch,

FIG. 7d shifting from the starting transmission ratio step into a lower geared transmission ratio step,

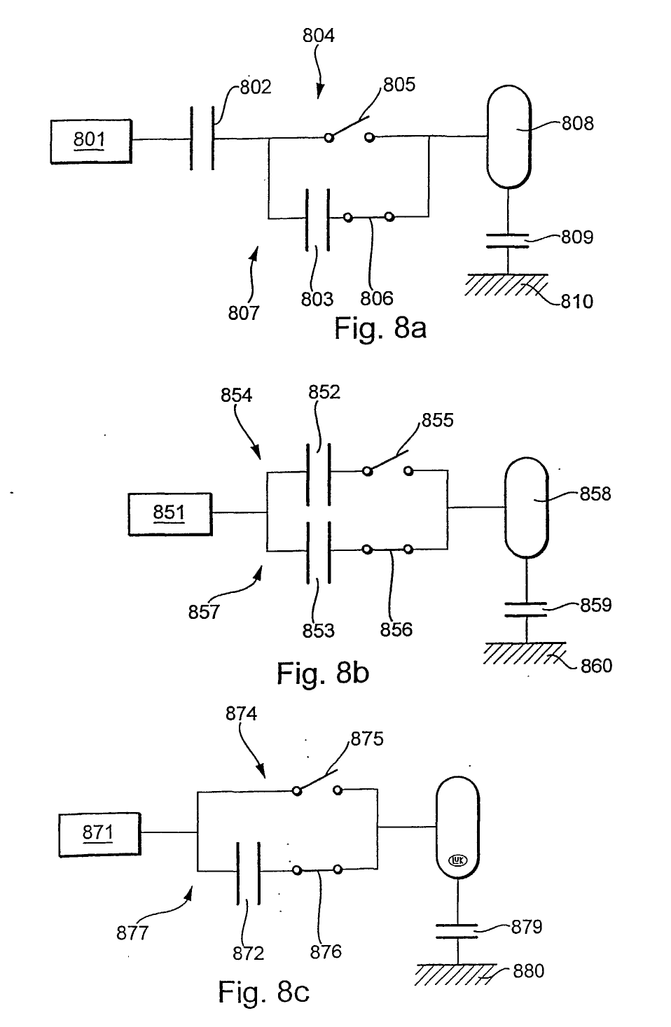

FIGS. 8a-c the drive path of a motor vehicle with starting and load-shifting clutches during the determination of the contact point of the load-shifting clutch,

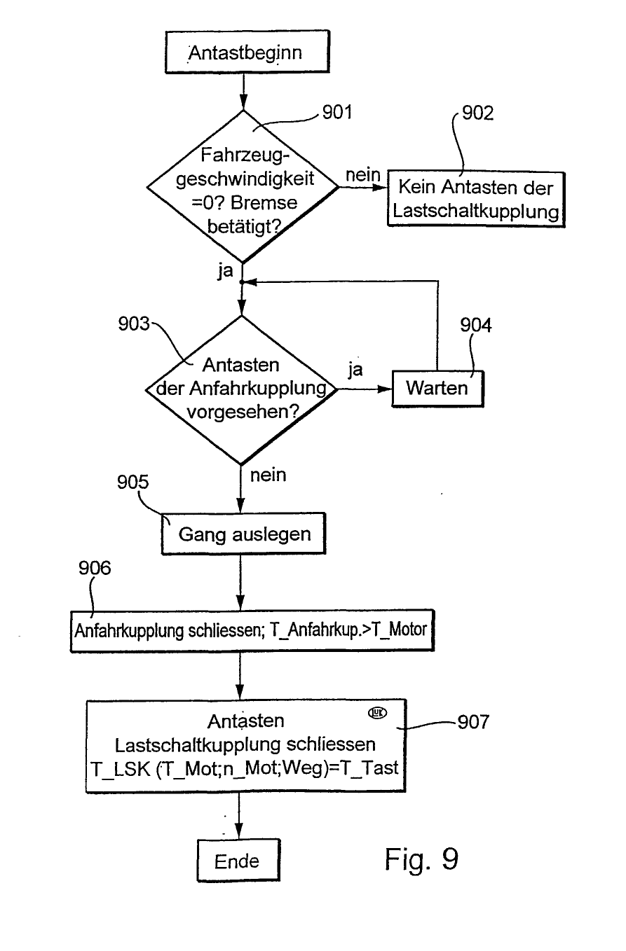

FIG. 9 a diagram for determining the contact point of the load-shifting clutch,

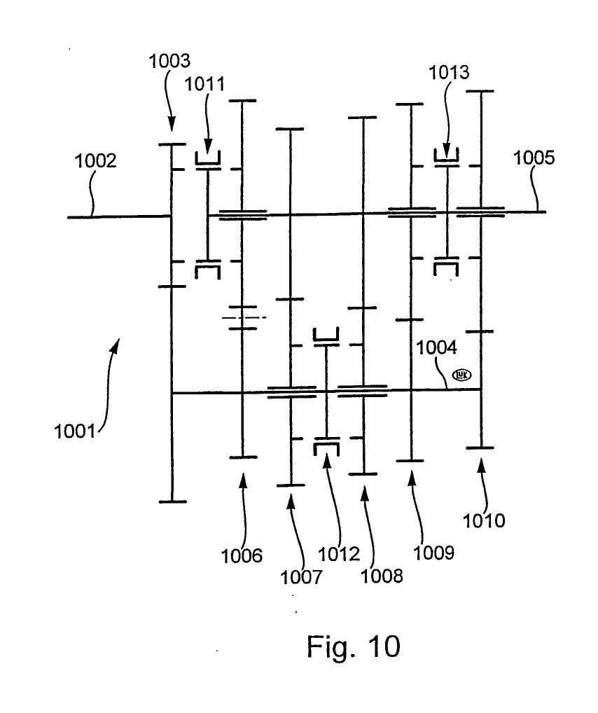

FIG. 10 a schematic transmission structure,

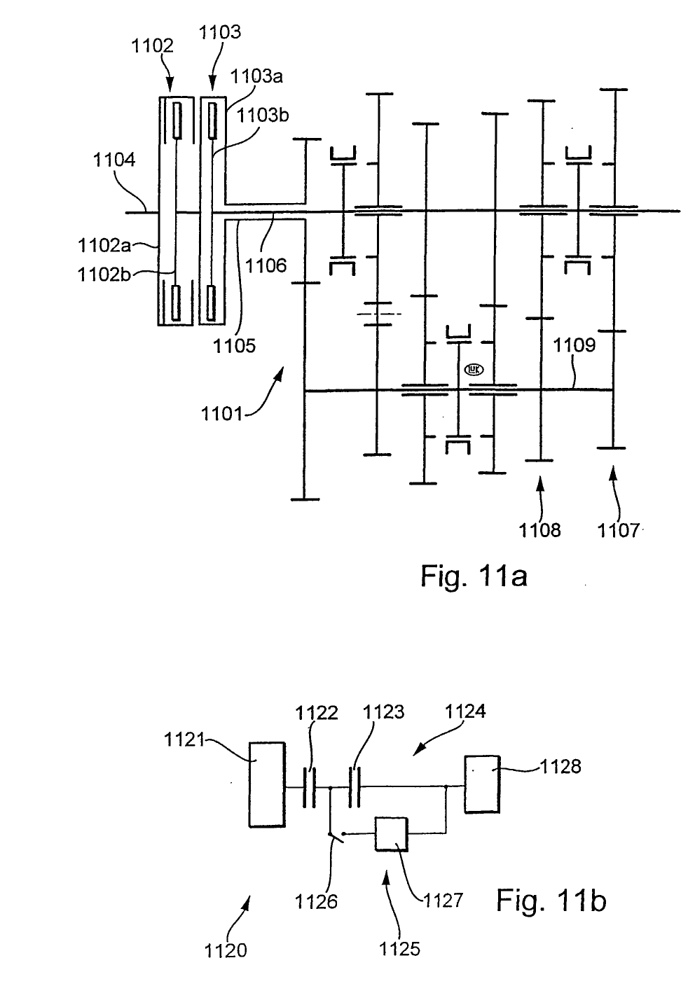

FIG. 11a a serial arrangement of the clutches in schematic form,

FIG. 11b a connection diagram,

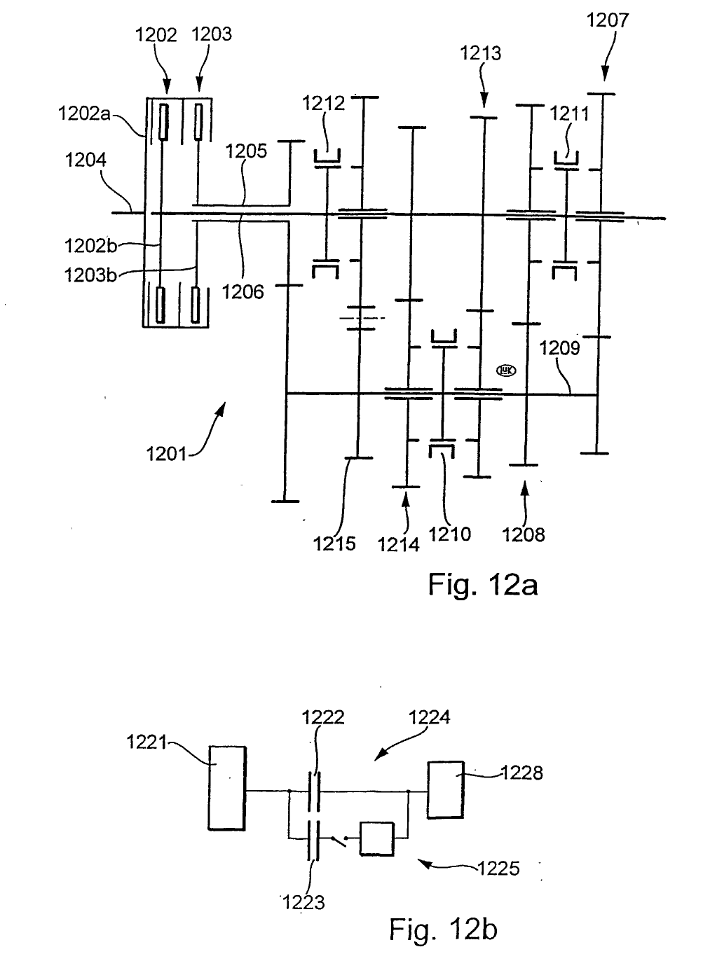

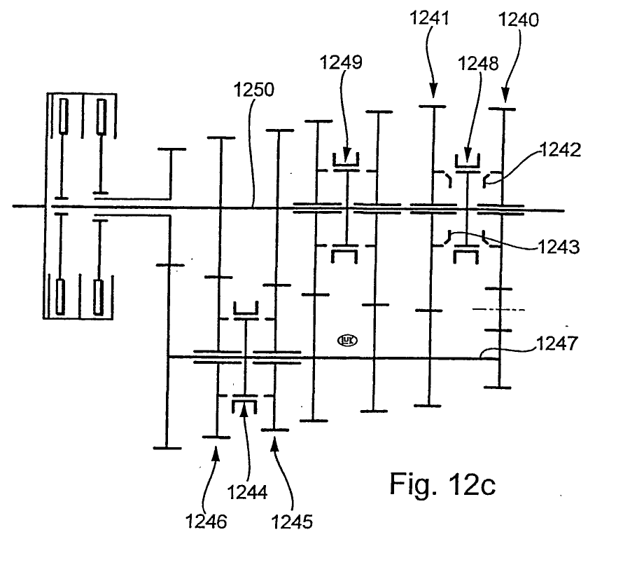

FIG. 12a a parallel arrangement of the clutches in schematic form,

FIG. 12b a connection diagram,

FIG. 12c a parallel arrangement of the clutches in schematic form,

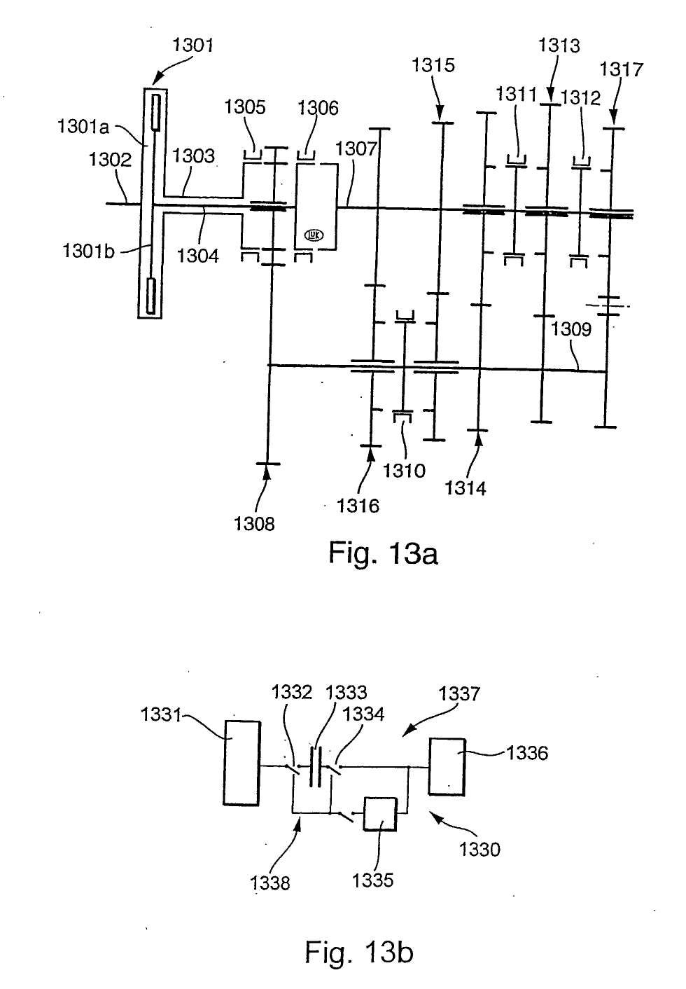

FIG. 13a an arrangement with only one clutch in schematic form, and

FIG. 13b a connection diagram.

FIG. 1 shows a plurality of schematic connection plans for arranging the starting and/or load-shifting clutches, as well as groups of transmission ratio steps with reference to the transmission paths, whereby a transfer of driving torque from an input shaft 114, 124, 134, 144, 154, 164, or 174 is possible selectively through a transmission path 111, 121, 131, 141, 151, 161, or 171 and/or another transmission path 112, 122, 132, 142, 152, 162, or 172 to an output shaft 113, 123, 133, 143, 153, 163, or 173.

On principle, shifts with reduced tractive force interruption are basically possible if the flow of torque between input shaft 114, 124, 134, 144, 154, 164, or 174 and output shaft 113, 123, 133, 143, 153, 163, or 173 is not excessively diminished or interrupted during the shifting procedure, which can be attained when the flow of torque during the change from one transmission ratio condition to another, following the principle of the double clutch transmission, is either diverted with reduced tractive force interruption from one transmission path in which one transmission ratio condition is set through an activation of the clutches associated with the transmission paths in a shifting variation to another transmission path, in which another transmission ratio condition is set, or wherein for switching from one transmission ratio condition to another in the same transmission path, the flow of torque is temporarily conducted over the other transmission path during the shifting procedure.

At the same time, the input shaft must be separable from the starting transmission ratio steps, such as first and reverse gear, as well as, if necessary, further transmission ratio steps. The separability can be attained, for example, with a friction clutch that is presently designated through its primary function as a starting clutch.

Further, in the event that the flow of torque is temporarily conducted over the other transmission path during the shifting process for changing from one transmission ratio step into another of the same transmission path, whereby a clutch presently designated in accordance with its primary function as load-shifting clutch is used, for reduced tractive force interruption in an upshift during acceleration the load-shifting clutch must be connectable with a transmission ratio step whose transmission ratio is smaller than that of the transmission ratio step into which the shift is to be made. For reduced tractive force interruption in a downshift during deceleration, the load-shifting clutch must be connectable with a transmission ratio step whose transmission ratio is higher than the transmission ratio step into which shifting is to take place. Furthermore, it should be pointed out that the reduction of tractive force is less the lower the transmission ratio difference between the transmission ratio step with which the load-shifting clutch is connected and the transmission ratio step into that it is to be shifted.

Exemplary embodiments are shown in connection diagrams 110, 120, 130, 140, 150, 160, and 170, that advantageously satisfy the requirements described above. Nonetheless, it can also be appropriate to carry out the concepts of the invention in another manner than represented here. In particular, it can be of advantage if the groups of transmission ratio steps described below are in any given case included in the other transmission path. If in the event that starting and load-shifting clutches are separated, the transmission paths are in each case associated with the other clutch or, in the event that a clutch usable as a starting as well as a load-shifting clutch is provided, that clutch is associated with the other transmission path.

With connection diagrams 110 and 120, the use of the invention with a 6 speed or 5-speed transmission is shown. The transmission includes a transmission path 111, 121 between input shaft 114, 124 and output shaft 113, 123 that includes all transmission ratio steps to be shifted with reduced tractive force interruption, outside the lowermost transmission ratio step and that is not separable from the input shaft 114, 124. A transmission path 112, 122 parallel to those between input shaft 114, 124 and output shaft 113, 123 includes a clutch 115, 125 acting as a load-shifting clutch as well as a starting clutch, as well as in any given case the transmission ratio steps with the highest or lowest transmission ratio, such as first gear and fifth gear or sixth gear, and starting transmission ratio steps, such as first gear and reverse gear with which the clutch 115, 125 is connectable. A transmission ratio step of identical transmission ratio is contained in transmission path 111, 121 as well as in transmission path 112, 122. Presently the first gear is present in both paths. In that way, it is possible to start by engaging clutch 115, 125 with first gear engaged in the transmission path 111, 121 and, with completely engaged clutch 115, 125, to guide the flow of torque through transmission path 111, 121 with the first gear engaged. As soon as the transmission 112, 122 is free of load, the clutch 115, 125, henceforth not operating as a load-shifting clutch can be connected with the fifth or sixth gear so that upshifts with reduced tractive force interruption are made possible in all further gears of the transmission paths 111, 121. For downshifts with reduced tractive force interruption, the clutch 115, 125 is connected with the first gear, whereby all transmission ratio steps arranged in transmission path 111, 121 can be shifted back during deceleration. A change in the transmission ratio step with the lowest transmission ratio, with reduced tractive force interruption, takes place when the clutch 115, 125 slips. The start up process and the transition to load-shifting operation, as well as the flow of torque in particular, are shown and described in detail in this connection in FIGS. 7a to 7d. A basic difference between those embodiments shown in connection diagrams 110 and 120 from those shown in connection diagrams 140, 160 and 170 is the structural presence of transmission ratio steps, presently the first gear, in path 111 or 121 as well as in path 112 or 122, in contrast to that in the embodiments shown in connection diagrams 140, 160 and 170, transmission ratio steps are present only once, but are associated with both transmission paths, which is indicated in FIG. 1 by a dotted line representation. Refer to FIGS. 2 to 6b and their description for further details.

Exemplary embodiments of the invention are shown in connection diagrams 130 and 150, in which starting and load-shifting clutches are provided separately, each associated with one transmission path.

In the exemplary embodiment shown in connection diagram 130, the two parallel transmission paths 131 and 132 lie between input shaft 134 and output shaft 133, whereby gears 1, 2, 3, 4, and reverse are included in path 131 that is associated with starting clutch 136, and gears 3 and 5 in path 132 that is associated with load-shifting clutch 135. Load-shifting clutch 135 is thus selectively connectable with third gear or with fifth gear. Appropriately, third gear is present in path 131 as well as in path 132. If the load-shifting clutch 135 is connected with third gear, gears 1, 2, and 3 can be upshifted with reduced tractive force interruption. In the event that load-shifting clutch 135 is connected with fifth gear, upshifting into fourth gear can be effected with reduced tractive force interruption. A downshift with reduced tractive force interruption into third gear of path 131 is possible if the load-shifting clutch 135 is connected with the third gear of path 132. Besides those shifts with reduced tractive force interruption typical for interruption-free transmission, shifts with reduced tractive force interruption are possible in the present exemplary embodiment according to the principle of a double clutch transmission, since by activation of clutches 136 and 135, for example, a change is made between the second or fourth gear of path 131 and the third or fifth gear of path 132. A change of the flow of torque between the two transmission paths 131 and 132 with identical transmission ratio of third gear is also possible. The arrangement shown in connection diagram 130 is especially advantageous, since in any given case the difference in the transmission ratio between the transmission ratio step with which load-shifting clutch 135 is connected and the transmission ratio into which a change is to be made with reduced tractive force interruption is small, and therefore the tractive force interruption as well as the energy input into load-shifting clutch 135 during the shifting process is correspondingly minimized. In accordance with a further feature of this exemplary embodiment, the startup transmission ratio steps of first gear and reverse gear are included in transmission path 131 associated with the starting clutch, so that a startup using the starting clutch 136 is possible in those transmission ratio steps. If necessary, it can also be appropriate to start using the starting clutch 136 in second gear, for example with diminished road traction of the vehicle wheels, or using load-shifting clutch 136 in connection with a transmission ratio step of transmission path 132 for a startup procedure. Refer to FIG. 2 and its description in connection with the embodiment shown in connection diagram 130.

In the embodiment shown in connection diagram 150 the two parallel transmission paths 151 and 152 lie between input shaft 154 and output shaft 153, whereby gears 1, 2, 3 and 4 are included in path 151 that is associated with starting clutch 156, and gears 1, 5, and reverse are included in path 152 that is associated with load-shifting clutch 155. Load-shifting clutch 155 is thus selectively connectable with first gear, fifth gear, or with reverse gear. Appropriately, first gear is presently situated in path 151 as well as in path 152. If the load-shifting clutch 155 is connected with fifth gear, the gears of path 151 can be upshifted with reduced tractive force interruption. A downshift with reduced tractive force interruption is possible if load-shifting clutch 155 is connected with the first gear of path 152. Besides those shifts with reduced tractive force interruption, typical for an interruption-free transmission of this type, shifts with reduced tractive force interruption in the present exemplary embodiment according to the principle of a double clutch transmission are possible, as by activation of clutches 156 and 155 in shift changes, for example, a change between the fourth gear of path 151 and the fifth gear of path 152, or between the first gear of path 152 and the second gear of path 151. Even a change of the flow of torque between the two transmission paths 151 and 152 with identical transmission ratio of first gear is possible. The arrangement shown in connection diagram 150 is especially advantageous in that in any given case all transmission ratio steps of path 151 can be upshifted with reduced tractive force interruption when load-shifting clutch 155 is connected with fifth gear, and can be downshifted when load-shifting clutch 155 is connected with first gear. In accordance with a further feature of this exemplary embodiment, the startup transmission ratio step of first gear is included in transmission path 151 associated with the starting clutch, so that a startup using the starting clutch 156 is possible in this transmission ratio step. If necessary, it can also be appropriate to start using the starting clutch 156 in second gear, for example with diminished road traction of the vehicle wheels. Starting up in another transmission ratio step associated with starting clutch 156 can also be advantageous. Furthermore, the present arrangement also makes possible a start up in first gear or in reverse gear of transmission path 153 using the load-shifting clutch 155, especially if only a small starting torque is needed. Refer to FIG. 3a and its description in connection with the embodiment shown in connection diagram 150.

Through the structural separation of load-shifting clutch 135 or 155 and starting clutch 136 or 156, it becomes possible basically to use the starting clutch 136 or 156 for startup procedures and load-shifting clutch 135 or 155 mainly for load-shifting. In that way, for example, the thermal and/or mechanical demands on the load-shifting clutch 135 or 155 are basically smaller, which has a positive effect on design and configuration, especially with regard to space. The load-shifting clutch 135 or 155 can be built smaller in comparison with the starting clutch 136 or 156.

The embodiments shown in connection diagrams 140, 160, and 170 show, like those illustrated in connection diagrams 110 and 120, a clutch 145, 165, or 175 that can be used as a starting as well as a load-shifting clutch, and that is associated with a transmission path 142, 162, or 172, in contrast to which the other transmission path 141, 161, or 171 is associated with no clutch and consequently is not separable from input shaft 144, 164, or 174.

In the embodiment shown in connection diagram 140, the two parallel transmission paths 141 and 142 lie between input shaft 144 and output shaft 143, whereby transmission ratio steps of gears 1, 2, 3, and 4 are included in path 141, and transmission ratio steps 1, 5, and reverse gear are included in path 142 that is associated with clutch 145, and which are connectable with clutch 145. Appropriately, first gear is presently associated with path 141 as well as with path 142, but is structurally present only once. If clutch 145 is connected with fifth gear, the gears of path 141 can be upshifted with reduced tractive force interruption. A downshift with reduced tractive force interruption is possible if clutch 145 is connected with the first gear of path 142. By a continuous engagement of clutch 145, an appropriate change with reduced tractive force interruption is made possible, for example from fourth into fifth gear. In particular for an important starting procedure, the possibility of a change of torque flow between the two transmission paths 142 and 141 at identical transmission ratio of the first gear exists, since very advantageously it is possible to start up using clutch 145 connected with first gear, and then a change with reduced tractive force interruption from first gear that is associated with path 141 can take place for further shifting to gears 2 to 4 with reduced tractive force interruption, whereby clutch 145 can then be connected with another gear as soon as it is at least approximately load-free. It is especially advantageous with the arrangement shown in connection diagram 140 that in each case all transmission ratio steps of path 141 can be upshifted with reduced tractive force interruption when clutch 145 is connected with fifth gear, and can be downshifted when clutch 145 is connected with first gear. In accordance with a further feature of this exemplary embodiment, the starting transmission ratio steps of first gear and reverse gear are included in transmission path 142 associated with clutch 145, so that a startup using clutch 145 is possible in those transmission ratio steps. Refer to FIG. 3b and its description in connection with the embodiment illustrated in connection diagram 140.

In connection diagram 160, the two parallel transmission paths 161 and 162 lie between input shaft 164 and output shaft 163, whereby transmission ratio steps of gears 1, 2, 3, and 4 are included in path 161, and transmission ratio steps 1, 3, 5, and reverse gear are included in path 162 that is associated with clutch 165, and with which clutch 165 is connectable. Appropriately, first gear is presently associated with path 161 as well as with path 162, but is structurally present only once. If clutch 165 is connected with third gear, gears 1, 2 and 3 of path 161 can be upshifted with reduced tractive force interruption. If clutch 165 is connected with fifth gear, fourth gear can be upshifted with reduced tractive force interruption. A shift with reduced tractive force interruption into fifth gear is attained by continuous engagement of clutch 165 connected with fifth gear. A downshift with reduced tractive force interruption into gears 4 and 3 is possible if clutch 165 is connected with the third gear of path 162. Gears 2 and 1 can be downshifted with reduced tractive force interruption if clutch 165 is connected with first gear. In particular for a starting procedure of significance, the possibility of a change of torque flow between the two transmission paths 162 and 161 at identical transmission ratio of the first gear exists, since very advantageously it is possible to start using clutch 165 connected with first gear, and then a change with reduced tractive force interruption to first gear that is associated with path 161 can take place for further shifting of gears 2 to 4 with reduced tractive force interruption, whereby clutch 165 can then be connected with another gear as soon as it is at least approximately load-free. It is especially advantageous with the arrangement shown in connection diagram 160 that in each case the difference between the transmission ratio of the transmission ratio steps with which clutch 165 is connected and the transmission ratio into which a change is to be made with reduced tractive force interruption is small, and therefore the tractive force interruption as well as the energy input into clutch 165 is correspondingly minimized during the shifting process. In accordance with a further feature of this embodiment, the starting transmission ratio steps of first gear and reverse gear are included in transmission path 162 associated with clutch 165, so that a startup using clutch 165 is possible in those transmission ratio steps. If necessary, it can also be appropriate to start up in third gear using clutch 165, for example with diminished road traction of the vehicle wheels. Refer to FIG. 4 and its description in connection with the embodiment shown in connection diagram 160.

In connection diagram 170, the two parallel transmission paths 171 and 172 lie between input shaft 174 and output shaft 173, whereby transmission ratio steps of gears 1, 2, 3, and 4 are included in path 171, and transmission ratio steps 1, 2, 5 and reverse gear are included in path 172 that is associated with load-shifting clutch 175, and with which clutch 175 is connectable. Appropriately, first gear is presently associated with path 171 as well as with path 172, but is structurally present only once. If clutch 175 is connected with second gear, gears 1 and 2 of path 171 can be upshifted with reduced tractive force interruption. If clutch 175 is connected with fifth gear, fourth gear can be upshifted with reduced tractive force interruption. A shift with reduced tractive force interruption into fifth gear is attained by continuous engagement of clutch 175 connected with fifth gear. A downshift with reduced tractive force interruption into gears 4, 3, and 2 is possible if load-shifting clutch 175 is connected with the second gear of path 172. First gear can be downshifted with reduced tractive force interruption if clutch 175 is connected with first gear. In particular for a starting procedure of significance, the possibility of a change of torque flow between the two transmission paths 172 and 171 at identical transmission ratio of the first gear exists, since very advantageously it is possible to start using clutch 175 connected with first gear and then a change with reduced tractive force interruption to first gear, that is associated with path 171, can take place for further shifting of gears 2 to 4 with reduced tractive force interruption, whereby clutch 175 can then be connected with another gear as soon as it is at least approximately load-free. It is especially advantageous with the arrangement shown in connection diagram 170 that in each case the difference between the transmission ratio of the transmission ratio steps with which clutch 175 is connected and the transmission ratio into which a change should be made with reduced tractive force interruption is small. Therefore, the tractive force interruption, as well as the energy input into clutch 175, is correspondingly minimized during the shifting process. In accordance with a further feature of this embodiment, the starting transmission ratio steps of first gear and reverse gear are included in transmission path 172 associated with clutch 175, so that a startup using clutch 175 is possible in those transmission ratio steps. If necessary, it can also be appropriate to start up using clutch 175 in second gear, for example with diminished road traction of the vehicle wheels. Refer to FIG. 5 and its description in connection with the embodiment shown in connection diagram 170.

Through the structural combination of a load-shifting clutch and a starting clutch, as is shown by way of example in connection diagrams 110, 120, 140, 160, and 170, the saving of a large number of structural elements is made possible in an especially advantageous manner that has an especially favorable effect on the space required and manufacturing costs. In this way, a load shiftable transmission with only one clutch is realized in accordance with a basic concept of the invention.

FIG. 2 shows in a strongly schematic manner a configuration of the embodiment shown in connection diagram 130 in FIG. 1. Two parallel transmission paths are formed with transmission input shafts 204 and 205 between input shaft 201 and transmission output shaft 206, which are connectable with input shaft 201 using a clutch unit 202. In the present exemplary embodiment, the transmission input shaft 204 is constructed as a hollow shaft surrounding transmission input shaft 205, but it can also be appropriate in another exemplary embodiment if the transmission input shaft 205 is constructed as a hollow shaft and the transmission input shaft 204 is constructed as a solid shaft. The clutch unit 202 includes two clutch disks 202a, 202b with which two clutches are formed, that can be actuated automatically, for example using an actuator 203 through an electrical control unit. The clutch disk 202a is presently associated with a first transmission input shaft 205 that carries the gears of first, second, third, and fourth gears; clutch disk 202b is associated with the second transmission input shaft 204 that carries a gear of the fifth gear. The gears of the transmission ratio steps are arranged on the transmission input shaft 205 in the sequence third gear, second gear, fourth gear, and first gear when viewed from the end region of the hollow shaft, whereby another arrangement can also be appropriate in another exemplary embodiment. A connection of gears one and four with shaft 205 can take place using sliding sleeve 216, second gear 210 is shiftable using sliding sleeve 215, and fifth gear 208 can be shifted using sliding sleeve 214. Third gear 209 is especially advantageously arranged axially in the vicinity of the end region of shaft 204 constructed as a hollow shaft and arranged on the transmission input shaft 205, so that it can be shifted using sliding sleeve 215 arranged on shaft 205 as well as using sliding sleeve 214 arranged on shaft 204, and consequently is connectable with transmission shaft 205 as well as with hollow shaft 204. Presently, third gear is structurally present only once, but can be used in both transmission paths. Sliding sleeves 214, 215, and 216 can be automatically operated through a control device, for example by means of an actuator 207. Appropriately, actuator 207 includes two drives for activating the sliding sleeves, whereby one drive is provided for selection of a clutch disk to be actuated, corresponding to a selection movement, and another drive is provided for generating a shifting movement. In any given case the second gears of transmission ratio steps 208, 209, 210, 211, and 213 are arranged on transmission output shaft 206. A reverse gear 212 is arranged in the first transmission input shaft 205, and is consequently connectable through clutch 202a with input shaft 201. In the present exemplary embodiment, it is very advantageous that synchronization devices must only be provided for shifting fifth gear 208 and third gear 209 using sliding sleeve 214. No synchronization devices need be provided for sliding sleeves 215 and 216. Furthermore, it is very advantageous that no transmission ratio step is doubly present, which has a positive effect upon space and manufacturing cost in particular. In the present exemplary embodiment, the idler gears of the transmission ratio steps and consequently also the sliding sleeves are arranged on shaft 204 or 205. In another exemplary embodiment it nevertheless can also be appropriate if at least some of the idler gears are arranged on shaft 206.

FIG. 3a shows in a strongly schematic manner a configuration of the exemplary embodiment shown in connection diagram 150 in FIG. 1. Two parallel transmission paths are formed by transmission input shafts 304 and 305 between input shaft 301 and transmission output shaft 306 that are connectable with input shaft 301 by a clutch unit 302. In the present exemplary embodiment, the transmission input shaft 304 is constructed as a hollow shaft surrounding transmission input shaft 305, but it can also be appropriate in another exemplary embodiment if the transmission input shaft 305 is constructed as a hollow shaft and the transmission input shaft 304 is constructed as a solid shaft. The clutch unit 302 includes two clutch disks 302a, 302b with which two clutches are formed that can be actuated automatically, for example by an actuator 303 through an electrical control unit. Clutch disk 302a is presently associated with a first transmission input shaft 305 that carries gears of first, second, third, and fourth gears; clutch disk 302b is associated with the second transmission input shaft 304 that carries a gear of the fifth gear. The gears of the transmission ratio steps are arranged on the transmission input shaft 305 in the sequence first gear, second gear, third gear, and fourth gear when viewed from the end region of the hollow shaft, whereby another arrangement can also be appropriate in another exemplary embodiment. A connection of gears three and four with shaft 305 can take place using sliding sleeve 316; second gear 311 is shiftable using sliding sleeve 315; and fifth gear 308 can be shifted using sliding sleeve 314. First gear 310 is especially advantageously arranged axially in the vicinity of the end region of shaft 304, constructed as a hollow shaft of the transmission input shaft 305, so that it can be shifted using sliding sleeve 315 arranged on shaft 305 as well as using sliding sleeve 314 arranged on shaft 304, and consequently is connectable with transmission shaft 305 as well as with hollow shaft 304. Presently, first gear is structurally present only once, but it can be used in both transmission paths. Sliding sleeves 314, 315, and 316 can be automatically actuated through a control device, for example by means of an actuator 307. Appropriately, actuator 307 includes two drives for activating the sliding sleeves, whereby one drive is provided for selection of a sliding sleeve to be actuated, corresponding to a selection movement, and another drive is provided for generating a shift movement. In any given case the second gears of transmission ratio steps 308, 310, 311, 312, and 313 are arranged on transmission shaft 306. A reverse gear 309 is arranged in the second transmission input shaft 304, and is consequently connectable with input shaft 301 through clutch 302b. In the present exemplary embodiment, it is very advantageous that synchronization devices must only be provided for shifting fifth gear 308 and first gear 310 using sliding sleeve 314, while no synchronization devices need be provided for sliding sleeves 315 and 316. Furthermore, it is very advantageous that no transmission ratio step is doubly present, which has a particularly positive effect upon space and manufacturing cost. In the present exemplary embodiment, the idler gears of the transmission ratio steps and consequently also the sliding sleeves are arranged on shaft 304 or 305. In another exemplary embodiment it nevertheless can also be appropriate if at least some of the idler gears are arranged on shaft 306.

FIG. 3b shows in a strongly schematic manner a configuration of the embodiment shown in connection diagram 140 in FIG. 1. Two parallel transmission paths are formed with transmission input shaft 354 and transmission input shaft 351, which is at the same time an input shaft, whereby only the transmission path formed by transmission input shaft 354 is separable from input shaft 351 using a clutch 352. In the present exemplary embodiment, the transmission input shaft 354 is constructed as a hollow shaft surrounding transmission input shaft/drive shaft 351. But it can also be appropriate in another exemplary embodiment if the transmission input shaft/drive shaft 351 is constructed as a hollow shaft and the transmission input shaft 354 is constructed as a solid shaft. The clutch 352 can be actuated automatically, for example using an actuator 353 through an electrical control unit. Transmission input shaft/drive shaft 351 presently carries gears of first, second, third, and fourth gears, and transmission input shaft 354 carries a gear of the fifth gear. The gears of the transmission ratio steps are arranged on transmission input shaft/drive shaft 351 in the sequence first gear, second gear, third gear, and fourth gear when viewed axially from the end region of the hollow shaft, whereby another arrangement can also be appropriate in another exemplary embodiment. A connection of gears three and four with shaft 351 can take place using sliding sleeve 366; second gear 361 is shiftable using sliding sleeve 365; and fifth gear 358 can be shifted using sliding sleeve 364. First gear 360 is especially advantageously arranged on transmission input shaft/drive shaft 351 axially in the vicinity of the end region of shaft 354, constructed as a hollow shaft, so that it can be shifted using sliding sleeve 365 arranged on shaft 351 as well as using sliding sleeve 364 arranged on shaft 354, and consequently is connectable with transmission shaft 351 as well as with hollow shaft 354. Presently, first gear is structurally present only once but can be used in both transmission paths. Sliding sleeves 364, 365, and 366 can be automatically actuated through a control device, for example by means of an actuator 357. Appropriately, actuator 357 includes two drives for actuating the sliding sleeves, whereby one drive is provided for selection of a sliding sleeve to be actuated, corresponding to a selection movement, and another drive is provided for generating a shift movement. In any given case the second gears of transmission ratio steps 358, 360, 361, 362, and 363 are arranged on transmission output shaft 356. A reverse gear 359 is associated with transmission input shaft 354, and is consequently connectable with input shaft 351 through clutch 352. In the present exemplary embodiment, it is very advantageous that synchronization devices must only be provided for shifting fifth gear 358 and first gear 360 using sliding sleeve 364, while no synchronization devices need be provided for sliding sleeves 365 and 366. Furthermore, it is very advantageous that no transmission ratio step is doubly present, which has a positive effect upon space and manufacturing cost in particular. In the present exemplary embodiment, the idler gears of the transmission ratio steps and consequently also the sliding sleeves are arranged on shaft 351 or 354. In another exemplary embodiment it nevertheless can also be appropriate if at least some of the idler gears are arranged on shaft 356.

FIG. 4 shows in a strongly schematic manner a configuration of the exemplary embodiment shown in connection diagram 160 in FIG. 1. Two parallel transmission paths are formed with transmission input shaft 404 and transmission input shaft 401, which is at the same time a drive shaft, whereby only the transmission path formed by transmission input shaft 404 is separable from drive shaft 401 by a clutch 402. In the present exemplary embodiment, the transmission input shaft 404 is constructed as a hollow shaft surrounding transmission input shaft/drive shaft 401, but it can also be appropriate in another exemplary embodiment if the transmission input shaft/drive shaft 401 is constructed as a hollow shaft and the transmission input shaft 404 is constructed as a solid shaft. The clutch 402 can be actuated automatically through an electrical control unit, for example using an actuator 403. Transmission input shaft/drive shaft 401 presently carries gears of first, second, third, and fourth gears; transmission input shaft 404 carries gears of the fifth gear and the third gear. The gears of the transmission ratio steps are arranged on transmission input shaft/drive shaft 401 in the sequence first gear, second gear, third gear, and fourth gear, when viewed axially from the end region of the hollow shaft, whereby another arrangement can also be appropriate in another exemplary embodiment. A connection of third gear 413 and fourth gear 414 with shaft 401 can take place using sliding sleeve 416; second gear 412 is shiftable using sliding sleeve 417; and fifth gear 408 and third gear 409 of shaft 404 can be shifted using sliding sleeve 415. First gear 411 is especially advantageously arranged on transmission input shaft/drive shaft 401 axially in the vicinity of the end region of shaft 404, constructed as a hollow shaft, so that it can be shifted using sliding sleeve 417 arranged on shaft 401 as well as using sliding sleeve 416 arranged on shaft 404, and consequently is connectable with transmission shaft 401 as well as with hollow shaft 404. Presently, first gear is structurally present only once but can be used in both transmission paths. The third gear is also present in both transmission paths, and it is nonetheless also structurally present twice, which is appropriate in the present exemplary embodiment owing to construction conditions. In another exemplary embodiment it can also be appropriate when that gear is only present once, but is usable in different transmission paths. Sliding sleeves 415, 416, 417, and 418 can be automatically actuated through a control device, for example by means of an actuator 407. Appropriately, actuator 407 includes two drives for actuating the sliding sleeves, whereby one drive is provided for selection of a sliding sleeve to be actuated, corresponding to a selection movement, and another drive is provided for generating a shift movement. In any given case the second gears of transmission ratio steps 408, 409, 411, 412, 413, and 414 are arranged on transmission output shaft 406. A reverse gear 410 is associated with transmission input shaft 404, and is consequently connectable with input shaft 401 through clutch 402. In the present exemplary embodiment, it is very advantageous that synchronization devices must only be provided for shifting fifth gear 408 and third gear 409, as well as reverse gear 410 and first gear 411, using sliding sleeves 415 and 416, while no synchronization devices need be provided for sliding sleeves 417 and 418. In the present exemplary embodiment, the idler gears of the transmission ratio steps, and consequently also the sliding sleeves, are arranged on shaft 401 or 404. In another exemplary embodiment it nevertheless can also be appropriate if at least some of the idler gears are arranged on shaft 406.

FIG. 5 shows in a strongly schematic manner a configuration of the exemplary embodiment shown in connection diagram 170 in FIG. 1. Two parallel transmission paths are formed with transmission input shaft 504 and transmission input shaft 501, which is at the same time a drive shaft, whereby only the transmission path formed by transmission input shaft 504 is separable from drive shaft 501 using a clutch 502. In the present exemplary embodiment, the transmission input shaft 504 is constructed as a hollow shaft surrounding transmission input shaft/drive shaft 501, but it can also be appropriate in another exemplary embodiment if the transmission input shaft/drive shaft 501 is constructed as a hollow shaft and the transmission input shaft 504 is constructed as a solid shaft. The clutch 502 can be actuated automatically, for example using an actuator 503 through an electrical control unit. Transmission input shaft/drive shaft 501 presently carries gears of first gear 511, second gear 512, third gear 513, and fourth gear 514; transmission input shaft 504 carries gears of the fifth gear 508 and second gear 509. The gears of the transmission ratio steps are arranged on transmission input shaft/drive shaft 501 in the sequence first gear, second gear, third gear, and fourth gear when viewed axially from the end region of the hollow shaft, whereby another arrangement can also be appropriate in another exemplary embodiment. A connection of third gear 513 and fourth gear 514 with shaft 501 can take place using sliding sleeve 518; second gear 512 is shiftable using sliding sleeve 517; and fifth gear 508 and third gear 509 of shaft 504 can be shifted using sliding sleeve 515. First gear 511 is especially advantageously arranged on transmission input shaft/drive shaft 501 axially in the vicinity of the end region of shaft 504, constructed as a hollow shaft, so that it can be shifted using sliding sleeve 517 arranged on shaft 501 as well as using sliding sleeve 516 arranged on shaft 504, and consequently is connectable with transmission shaft 501 as well as with hollow shaft 504. Presently, first gear is structurally present only once but can be used in both transmission paths. The second gear is also present in both transmission paths, but it is also structurally present twice, which is appropriate in the present exemplary embodiment owing to construction conditions. In another exemplary embodiment it can also be appropriate when that gear is only present once, but is usable in different transmission paths. Sliding sleeves 515, 516, 517, and 518 can be automatically actuated through a control device, for example by means of an actuator 507. Appropriately, actuator 507 includes two drives for actuating the sliding sleeves, whereby one drive is provided for selection of a sliding sleeve to be actuated, corresponding to a selection movement, and another drive is provided for generating a shift movement. In any given case the second gears of transmission ratio steps 508, 509, 511, 512, 513, and 514 are arranged on transmission output shaft 506. A reverse gear 510 is associated with transmission input shaft 504, and is consequently connectable with input shaft 501 through clutch 502. In the present exemplary embodiment, it is very advantageous that synchronization devices must only be provided for shifting fifth gear 508 and second gear 509, as well as reverse gear 510 and first gear 511, using sliding sleeves 515 and 516, while no synchronization devices need be provided for sliding sleeves 517 and 518. In the present exemplary embodiment, the idler gears of the transmission ratio steps and consequently also the sliding sleeves are arranged on shaft 501 or 504. In another exemplary embodiment it nevertheless can also be appropriate if at least some of the idler gears are arranged on shaft 506.

FIG. 6a shows in a strongly schematic manner a configuration of the embodiment shown in connection diagram 110 in FIG. 1. Two parallel transmission paths are formed with transmission input shaft 604 and transmission input shaft 601, which is at the same time a drive shaft, whereby only the transmission path formed by transmission input shaft 604 is separable from input shaft 601 using a clutch 602. In the present exemplary embodiment, the transmission input shaft 604 is constructed as a hollow shaft surrounding transmission input shaft/drive shaft 601, but it can also be appropriate in another exemplary embodiment if the transmission input shaft/drive shaft 601 is constructed as a hollow shaft and the transmission input shaft 604 is constructed as a solid shaft. The clutch 602 can be actuated automatically, for example using an actuator 607 through an electrical control unit. Transmission input shaft/drive shaft 601 presently carries gears of first gear 614, second gear 613, third gear 612, and a common gear of fourth gear 619 and fifth gear 611. Transmission input shaft 604 carries a gear of the sixth gear 610 as well as a common gear of starting gear 609, that preferably has the same transmission ratio as the first gear, and reverse gear 620. The gears of the transmission ratio steps are arranged on transmission input shaft/drive shaft 601 in the sequence fifth gear/fourth gear, third gear, second gear, and first gear, when viewed axially from the end region of the hollow shaft, whereby another arrangement can also be appropriate in another exemplary embodiment. The additional gears of first gear 614, third gear 612, fourth gear 619, and reverse gear 620 are arranged on the transmission output shaft 606, whereby a connection of first gear 614 and third gear 612 with shaft 606 can take place using sliding sleeve 618. Fourth gear 619 and reverse gear 620 are shiftable using sliding sleeve 617. The further gears of second gear 613, fifth gear 611, sixth gear 610, and starting gear 609 are arranged on the transmission output shaft 605, whereby a connection of second gear 613 and firth gear 611 with shaft 605 can take place with sliding sleeve 616, and sixth gear 610 and starting gear 609 are shiftable by sliding sleeve 615. Presently, the starting gear 609 has the same gear ratio as first gear 614, whereby on the one hand that transmission ratio step for starting is separable from input shaft 601 using clutch 602; on the other hand, however, a change of torque flow with reduced tractive force interruption to shaft 606 can also take place for a shift with reduced tractive force interruption of the further transmission ratio steps. A shift in sixth gear 610 can be carried out with reduced tractive force interruption when clutch 602 is continuously engaged. Sliding sleeves 615, 616, 617, and 618 are automatically actuated through a control device, for example by actuators 603, 608. Appropriately, actuators 603, 608 include two drives for actuating the sliding sleeves, whereby one drive is provided for selection of a sliding sleeve to be actuated, corresponding to a selection movement, and another drive is provided for generating a shift movement. It is very advantageous in the present exemplary embodiment that synchronization devices must only be provided for shifting the starting gear 609 and sixth gear 610, which are arranged on shaft 605, while no synchronization devices need be provided for sliding sleeves 616, 617, and 618. In the present exemplary embodiment, the idler gears of the transmission ratio steps and consequently also the sliding sleeves are arranged on shaft 605 or 606. In another exemplary embodiment it nevertheless can also be appropriate if at least some of the idler gears are arranged on shaft 601 or 604.

FIG. 6b shows in a strongly schematic manner a configuration of the embodiment shown in connection diagram 120 in FIG. 1. Two parallel transmission paths are formed with transmission input shaft 654 and transmission input shaft 651, which is at the same time a drive shaft, whereby only the transmission path formed by transmission input shaft 654 is separable from input shaft 651 using a clutch 652. In the present exemplary embodiment, the transmission input shaft 654 is constructed as a hollow shaft surrounding transmission input shaft/drive shaft 651, but it can also be appropriate in another exemplary embodiment if the transmission input shaft/drive shaft 651 is constructed as a hollow shaft and the transmission input shaft 654 is constructed as a solid shaft. The clutch 652 can be actuated automatically through an electrical control unit, for example using an actuator 653. Transmission input shaft/drive shaft 651 presently carries gears of first gear 661, second gear 662, third gear 663, and fourth gear 664; transmission input shaft 654 carries gears of the fifth gear 659, reverse gear 660, and the starting gear 658, which preferably has the same gear ratio as first gear 661. The gears of the transmission ratio steps are arranged on transmission input shaft/drive shaft 651 in the sequence first gear, second gear, third gear, and fourth gear, when viewed axially from the end region of the hollow shaft, whereby another arrangement can also be appropriate in another exemplary embodiment. Fourth gear 664 can be connected with shaft 665 using sliding sleeve 668, a connection of third gear 663 and second gear 662 with shaft 665 can take place using sliding sleeve 667, first gear 661 as well as reverse gear 660 are shiftable using sliding sleeve 666; and fifth gear 659 as well as the starting gear 658 of shaft 654 can be shifted using sliding sleeve 665. Presently, the first gear arranged on shaft 651 and the starting gear 658 arranged on shaft 654 have the same gear ratio, whereby on the one hand that transmission ratio step is on the one hand separable using clutch 652 for starting with drive shaft 651, and on the other hand, however, a change with reduced tractive force interruption of the flow of torque to shaft 655 can nevertheless also take place for a shift with reduced tractive force interruption of further transmission ratio steps. A shift into fifth gear 659 can take place with reduced tractive force interruption by continuous engagement of clutch 652. Sliding sleeves 665, 666, 667, and 668 can be automatically actuated through a control device, for example by means of an actuator 657. Appropriately, actuator 657 includes two drives for activating the sliding sleeves, whereby one drive is provided for selection of a sliding sleeve to be actuated, corresponding to a selection movement, and another drive is provided for generating a shift movement. In any given case the other gears of transmission ratio steps 658, 659, 661, 662, and 664 are arranged on transmission shaft 665. A reverse gear 660 is associated with transmission input shaft 654, and is consequently connectable with input shaft 651 through clutch 652. In the present exemplary embodiment, it is very advantageous that synchronization devices must only be provided for shifting fifth gear 659 and starting gear 658 using sliding sleeve 665, while no synchronization devices need be provided for sliding sleeves 666, 667, and 668. In the present exemplary embodiment, the idler gears of the transmission ratio steps, and consequently also the sliding sleeves, are arranged on shaft 655. In another exemplary embodiment it nevertheless can also be appropriate if at least some of the idler gears are arranged on shaft 651 or 654.

The principle of multiple use of a transmission ratio step in different transmission paths represents an especially advantageous feature of the invention, and is also used in the above-described exemplary embodiments. In further constructions in which that inventive concept is used, it can nonetheless be altogether appropriate if another transmission ratio step, for example second, fourth, fifth, or reverse gear, can be used several times, or if more than one transmission ratio step can be used several times. Following the idea of arranging a transmission ratio in the region or at the end region of a hollow shaft, both ends of a hollow shaft can be used for multiple use of a transmission ratio step in accordance with the invention, or several shafts can be used in which one or both end regions can be used in the manner described.

FIGS. 7a to 7d show, by way of example, the flow of power during a starting process with the starting transmission ratio step and the transition to first gear in preparation for shifts of further transmission ratio steps with reduced tractive force interruption in the exemplary embodiment as it is shown in FIG. 6a. In FIG. 7a, the starting transmission ratio step 703 is shifted using sliding sleeve 704, so that the flow of torque 707 from drive shaft 701 through transmission input shaft 706 to transmission output shaft 705 can take place when clutch 702 is engaged. If clutch 722 is completely engaged, drive shaft 721, that is at the same time also a transmission input shaft, and the transmission input shaft 726 rotate at the same rotational speed, so that in addition to starting transmission ratio step 723, first gear 728, which has an identical gear ratio, can be shifted using sliding sleeve 730, and a flow of torque 727 from drive-/transmission input shaft 721 can take place over transmission output shaft 725 as well as over transmission output shaft 729. By disengaging clutch 742, shafts 748 and 746 below and therewith the starting transmission ratio step 749 can as a result be rendered load-free without tractive force being interrupted, since the full flow of torque 747 can take place directly through the drive-/transmission input shaft 741 and the transmission ratio step 743 to transmission output shaft 745. As shown in FIG. 7d, clutch 762 can then be connected with sixth gear 768 by means of sliding sleeve 766, wherewith second gear 770, third gear 771, fourth gear 772, and fifth gear 769 can be upshifted with reduced tractive force interruption. By a continuous engagement of clutch 762, sixth gear 768 and first gear 763 can be shifted with reduced tractive force interruption.

FIGS. 8a and 8b show by way of example and schematically the drive train of a motor vehicle with starting clutch 802, 852 and load-shifting clutch 803, 853 during determination of the contact point of load-shifting clutch 803, 853. The present exemplary embodiments each show two parallel transmission paths 804, 854 and 807, 857, whereby in FIG. 8a the starting clutch 802 is arranged in front of the branching point of the transmission paths viewed from the drive motor 801. Transmission path 804 includes no clutch, and transmission path 807 includes a load-shifting clutch 803. In FIG. 8b, the starting clutch included in transmission path 854 as well as the load-shifting clutch 853 included in transmission path 857 are arranged after the branching point when viewed from the drive motor 851, whereby transmission path 854 is associated with clutch 852 and transmission path 857 to clutch 853. To determine the contact point of the load-shifting clutch, it is necessary that by engaging the load-shifting clutch the drive path between the drive motor and vehicle wheel can be spanned at least to the value of the contact torque, without loss of torque at any position or torque led past the load-shifting clutch. This is made possible in the present exemplary embodiment of FIG. 8a in that the driven vehicle wheel 808 is connected with a brake 809 of the vehicle 810 such that at least up to the value of the contact torque, the brake 809 prevents rotation of wheel 808, clutch 802 is engaged to the extent that torque at least up to the value of the contact torque can be transferred loss free, the transmission path 804 is interrupted such that, for example, all associated shift clutches 805 are disengaged and one or more transmission ratio steps 806 of transmission path 807 are closed. If now clutch 803 is engaged, the power path between vehicle 810 and drive motor 801 can be spanned, whereby the entire torque is applied to load-shifting clutch 803. As the measurement for the increasing torque in path 607 between drive motor 801 and vehicle 810 from engagement of clutch 803, a rising torque can follow, or a value from which one such can be derived, in the region between drive motor 801 and clutch 803, or in the region between clutch 803 and vehicle 810, or a drop in rotational speed in the region between drive motor 801 and clutch 803, or a rise in rotational speed in the region between clutch 803 and vehicle 810, or an increased output demand on the drive motor 801, or one or more other suitable values can be drawn upon. If the torque in path 807 between drive motor 801 and motor vehicle 810 reaches the value of the contact torque, in the present exemplary embodiment the engagement position of clutch 803 is established by means of a suitable sensor, for example by means of a path sensor associated with a drive for clutch activation, and is stored; that position is associated with the contact point. Likewise, the contact point determination can be conducted with the structure shown in FIG. 8b. Nonetheless, in this instance, in order to meet the requirements described above, path 854 must be interrupted, while the clutch 852 is opened and/or all associated clutches 855 are opened, and one or more transmission ratio steps 856 of transmission path 857 are engaged, whereby the motor vehicle brake 859 is actuated to brake the driven vehicle wheel 858 against the motor vehicle. Thus, the drive path 857 between drive motor 851 and motor vehicle 860 can be spanned by engaging the clutch 853 for determining the contact point, at least up to the value of the contact torque. In accordance with the concept described, determining a contact point can also take place with a structure as shown in FIG. 8c. In that embodiment clutch 872 is constructed as a combined load-shifting/starting clutch. For determining a contact point it is presently necessary for the brake 879 to be actuated, the shift clutches 875 in path 874 to be disengaged, and for a transmission ratio step 876 to be engaged in path 877, so that the drive path from engaging clutch 872 between the drive motor and vehicle 880 can be spanned, at least up to the value of the contact torque. In all of the exemplary embodiments shown, a spanning of the drive path can also take place between the drive motor and the carried vehicle mass; activating the vehicle brake is then not necessary. In that case, a set vehicle movement or a rotation of the vehicle wheels can be relied upon to determine the contact torque, whereby advantageously the vehicle is situated on the level.

Furthermore, the present application is related to the older application DE 40 11 850.9, the content of which is expressly included in the disclosure of the present application.

An example of a sequence for determining the contact point of the load-shifting clutch with a structure as in FIG. 8a is shown in the diagram of FIG. 9. At the start, whether vehicle speed is equal to zero is examined, the vehicle is thus standing and a vehicle brake 809 is actuated, see block 901. If that is not the case, no determination of the contact point takes place, block 902, otherwise it is established in step 903 a contact point determination of starting clutch 802 is now provided. If that is the case, it is necessary to wait in determining the contact point of the load-shifting clutch (see block 904) until that is no longer the case and it is possible to proceed with the sequence, since all gears of path 804 are disengaged, step 905, and the starting clutch 802 is engaged in step 906, at least to the extent that a torque T_{starting clutch} greater than the motor torque Tₘₒₜₒᵣ is transmittable. With an engaged gear 806 in path 807, a contact point determination of the load-shifting clutch can take place as the clutch torque T_{LSK} on the load-shifting clutch 803 as a function of drive motor torque Tₘₒₜ, drive motor rotational speed nₘₒₜ, and the engagement path by engaging load-shifting clutch 803, see step 907, is increased until the contact torque T_{contact} is reached. The contact process is ended with the storing of that engagement position. Correspondingly analogously, a contact point determination can take place with a structure as shown in FIG. 8b, whereby it should be taken into account that the starting clutch 802 is arranged after the branching point in path 854.

FIG. 10 shows schematically and by way of example a transmission structure 1001 that can be used in which is shown an arrangement of the invention of starting, load-shifting, and shift clutches, as it is represented on the basis of the embodiments shown and described in the following figures. The transmission includes an input shaft 1002 connectable with a drive motor that is in engagement with a countershaft 1004 through a pair of gears 1003. A plurality of transmission ratio steps 1006, 1007, 1008, 1009, 1010 formed by gear pairs are arranged between countershaft 1004 and a transmission output shaft 1005, which in each case is formed by an escape wheel that is securely connected with a shaft, and an idler gear that is connectable with a shaft by means of a shift clutch 1011, 1012, 1013. The present exemplary embodiment includes four forward transmission ratio steps of this type 1007, 1008, 1009, 1010 and a reverse transmission ratio step 1006, whereby a fifth forward transmission ratio step is realized by a direct connection of input shaft 1002 with the transmission output shaft 1005 by means of shift clutch 1011. Besides such a 5-gear transmission, the invention can also be used in other transmissions, for example with a 6-gear transmission.

FIG. 11a shows schematically and by way of example a transmission structure 1101 in which there is a serial arrangement of a starting clutch 1101 and a load-shifting clutch 1103. Drive shaft 1104 is connected with the input element 1102a of the starting clutch 1102, the output element 1102b of which is connected with the input element 1103a of load-shifting clutch 1103. The input element 1103a of load-shifting clutch 1103 is connected with a first transmission input shaft 1105 that is constructed as a hollow shaft and encloses a second transmission input shaft 1006, with which the output element 1103b is connected. The starting clutch 1102 is presently arranged on the motor side, through which, as can be seen in the connection diagram 1120 in FIG. 11b, the entire remaining power path including also the load-shifting clutch 1103 is separable from the drive motor. Through that arrangement, for example, a startup can take place in first gear 1107, whereby the load-shifting clutch 1103 is disengaged. Moreover, during upshifting into second gear 1108, load-shifting clutch 1103 is engaged, so that during the shifting process, torque can continue to be applied to output shaft 1106. After the shifting process has taken place, the load-shifting clutch 1103 is again disengaged and the flow of torque then takes place once again through the countershaft 1109 while using the new gear. All further upshifts take place analogously. The starting clutch 1102 remains engaged during all shifting processes in this embodiment, whereby it can also be advantageous in another exemplary embodiment if the value of the torque made available by the starting clutch 1102 is at least occasionally adapted to requirements by a slipping operation or by disengagement.

The drive motor with following starting clutch 1122 is represented in connection diagram 11b by 1121. A branching of the drive path into a first path 1125 and a second path 1124, as shown in FIG. 11a, is realized through input element 1103a and output element 1103b of load-shifting clutch 1103 as well as connecting shafts 1105 and 1106. Two parallel transmission paths are formed with path 1124, through which driving torque is transferable in the present exemplary embodiment using the lowest transmission ratio of presently 1:1 in the transmission is transmittable to the drive wheels of the vehicle 1128, and path 1125, which includes a large number of gears with ratios 1127, presently a reverse gear as well as four forward transmission ratio steps that are higher than those that formed with path 1124, so that during an upshift process between transmission ratio steps in path 1125, torque can be conducted over path 1124 to the drive wheels of vehicle 1128, and tractive force interruption is thus reduced. The drive motor 1121 is separable in front of the branching point of the transmission paths 1124 and 1125 from the remaining power path by means of clutch 1122, so that that clutch remains engaged during load shifting.

FIG. 12a shows schematically and by way of example a transmission structure 1201 in which there exists a parallel arrangement of a load-shifting clutch 1202 and a starting clutch 1203, whereby the output element 1202b of load-shifting clutch 1202 is connected with a first transmission input shaft 1205, that is constructed as a hollow shaft and surrounds a second transmission input shaft 1206 with which the output element 1203b of starting clutch 1203 is connected. Clutches 1202 and 1203 have a common input element 1202a that is connected with drive shaft 1204. The load-shifting clutch 1202 is presently arranged on the motor side that in particular makes possible a larger clutch diameter and, associated therewith, a higher thermal load carrying capacity of the clutch. For example, a startup can take place through this arrangement in first gear 1207 by engaging the starting clutch 1203, whereby load-shifting clutch 1202 is disengaged. During upshifting into second gear 1208, load-shifting clutch 1202 is engaged so that torque can continue to be applied to output shaft 1206 during the shifting procedure. After the shifting process has taken place, load-shifting clutch 1202 is again disengaged so that the flow of torque now takes place again through the countershaft 1209 using the new gear. All further upshifts take place analogously. The starting clutch 1102 must not be engaged in this embodiment in order to be able to provide torque to the output shaft. In this embodiment, shifting clutch 1210 is arranged on the countershaft 1209 for activation of third gear 1213 and fourth gear 1214. Shifting clutches 1211 and 1212 are arranged on shaft 1206 for actuation of gears 1 and 2, as well as reverse gear 1215.

The drive motor with following input shaft is represented by 1221 in connection diagram 12b that, as shown in FIG. 12a, is connected with the input element 1202a, with which the output element 1202b of load-shifting clutch 1202 or the output element 1203b of starting clutch 1203 is connectable, through which a branching into two parallel transmission paths 1224 and 1225 with a branching point in front of both clutches 1222 and 1223 can be realized with the two following parallel transmission input shafts 1205 and 1206. By arranging the two clutches 1222 and 1223 in the transmission paths 1224 and 1225 after the branching point, torque can also be transferred to motor vehicle 1228 even with a disengaged starting clutch 1223, through which, in particular, further degrees of freedom in controlling the transmission result.

A further embodiment of the structure shown in connection diagram 12b is shown in FIG. 12c. In this embodiment, as a 6-gear transmission, synchronization devices 1242 and 1243 are provided on first gear 1241 and on reverse gear 1240, through which shifting is made possible when the vehicle is standing still. In another exemplary embodiment, it can also be advantageous if one or more brakes are provided that brings the shafts of the transmissions to a standstill in order to enable engaging the shifting clutches. Shifting clutch 1244 for activating fourth gear 1245 and fifth gear 1246 is arranged on the countershaft 1247 in this embodiment; shifting clutches 1248 and 1249 are arranged on shaft 1250 for actuating gears 1, 2, 3, as well as reverse gear 1240.

An embodiment of the invention is shown schematically and by way of example in FIG. 13a, in which a combined starting- and load-shifting clutch 1301 application is shown. The drive shaft 1302 is connected with the input element 1301a of clutch 1301, which furthermore is connected with a first transmission input shaft 1303 that is constructed as a hollow shaft and that surrounds a second transmission input shaft 1304, with which the output element 1301b of clutch 1301 is connected. The first transmission input shaft 1303 is connectable by means of shifting clutch 1305 with the countershaft 1309 through the transmission ratio formed by gear pair 1308. The second transmission input shaft 1304 is selectively connectable with countershaft 1309 or with output shaft 1307 using shifting clutch 1306. Shifting clutches 1310, 1311, and 1312 serve to shift first gear 1313, second gear 1314, third gear 1315, fourth gear 1316, as well as reverse gear 1317, whereby shifting clutch 1310 is arranged on shaft 1309 in the present exemplary embodiment, and shifting clutches 1311 and 1312 are arranged on shaft 1307.

The function is clarified in connection diagram 1330 in FIG. 13b. Drive motor 1331 is selectively connectable with clutch 1333 in transmission path 1337 or with path 1338 by means of shifting clutch 1332. A further branching is realized with shifting clutch 1334 through which the possibility also exists after clutch 1333 of conducting the flow of force selectively over path 1337 or over path 1338, including transmission ratio steps 1335, to the drive wheels of motor vehicle 1336. This arrangement also makes possible a startup in second gear 1314 which, for example, is advantageous in the event that a diminished driving torque, perhaps with low roadway friction such as winter slipperiness, is appropriate. The present exemplary embodiment makes possible improvements. A change in the arrangement of reverse gear 1317, for example, or another configuration of the sliding sleeves of the shifting clutches, can contribute to simplifying the overall arrangement, even a joint activation of the two shifting clutches 1305 and 1306 can bring decisive advantages in an improvement of the invention.

The inventive concepts disclosed with the transmission structures represented and described in FIGS. 11b, 12b, as well as 13b can be combined with additional inventive thoughts disclosed in the present application. In particular, the path of the load-shifting clutch in the embodiments represented and described with FIGS. 11b, 12b, as well as 13b can include more than one transmission ratio step, through which the advantages shown and described with the previous figures can also be attained here. In particular, a reduced tractive force upshift and downshift can be attained for all transmission ratio steps. Furthermore, with all embodiments described and illustrated, the use of a clutch cooled, for example, by ventilation can also extend the range of transferable torque upward. Even the use of a non-removable cover releasing device is advantageously made possible. The clutches shown and described can be constructed as combined clutches with a common actuation device, whereby in other embodiments, the use of separate actuation devices can also be very advantageous.

The patent claims submitted with the application are formulation proposals without prejudice for attaining further-reaching patent protection. The applicant reserves the right to disclose further features beyond those disclosed up until now in the description and/or drawings.

References back used in dependent claims refer to the further construction of the object of the main claim through the features of the dependent claim in question. They are not to be understood as a waiver of attaining an independent, objective protection for the claims of the dependent claims to which they refer.

The objects of those dependent claims nonetheless also form independent inventions that have a configuration independent of the objects of preceding dependent claims.

The invention is also not restricted to the embodiments of the description. Rather, numerous amendments and modifications are possible within the scope of the invention, especially such variants, elements, and combinations and/or materials that, for example, are inventive through combination or transformation of individual features or elements described in connection with the general description and embodiments as well as in the claims and contained in the drawings, and that lead through combined features to a new object or to new processing steps or sequences of processing steps, and also to this extent concern manufacturing, testing, and operating procedures.

1. Transmission with an input shaft connectable with a drive motor, at least two transmission input shafts and a transmission output shaft, through which parallel transmission paths are formed, at least one clutch, such as a friction clutch, characterized in that at least one transmission ratio step can be load-shifted.

2. Transmission with an input shaft connectable with an input shaft, at least two transmission input shafts, through which at least a first and a second parallel transmission path is formed, a transmission output shift, and at least one clutch, such as a friction clutch, whereby
at least the first transmission path is associated with at least one transmission ratio step with reduced tractive force,
the second transmission path includes a transmission ratio step connectable with a clutch, such as a load-shifting clutch, and
the first or second transmission path includes at least one clutch, such as a starting clutch, associated with a starting transmission ratio step,
characterized in that the first transmission path is associated with at least two transmission ratio steps with respect to their transmission ratios, and all transmission ratio steps are shiftable with reduced tractive force interruption.

3. Transmission especially according to claim 1 or 2, characterized in that the transmission ratio steps can be upshifted with reduced tractive force interruption.

4. Transmission especially according to claim 1, 2 or 3, characterized in that the transmission ratio steps can be downshifted with reduced tractive force interruption.

5. Transmission especially according to claim 1 or 2-4, characterized in that a clutch that is basically usable as a starting clutch is associated with a transmission path, and a clutch that is basically usable as a load-shifting clutch is associated with another transmission path.

6. Transmission especially according to claim 5, characterized in that the transmission path associated with the starting clutch includes at least two transmission ratio steps that are successive with reference to their transmission ratios.

7. Transmission especially according to claim 5 or 6, characterized in that the transmission path associated with the starting clutch includes transmission ratio steps that are shiftable with reduced tractive force interruption.

8. Transmission especially according to claim 7, characterized in that the transmission path associated with the load-shifting clutch includes at least one transmission ratio step with a lower transmission ratio than the transmission ratio step to be shifted with reduced tractive force interruption, and the load-shifting clutch is connectable with that transmission ratio step.

9. Transmission especially according to claim 8, characterized in that the transmission path associated with the load-shifting clutch includes at least the transmission ratio step with the lowest transmission ratio, and the load-shifting clutch is connectable with that transmission ratio step.

10. Transmission especially according to claim 7, characterized in that the transmission path associated with the load-shifting clutch includes at least one transmission ratio step with a higher transmission ratio than that of the transmission ratio step to be shifted with reduced tractive force interruption, and the load-shifting clutch is connectable with that transmission ratio step.

11. Transmission especially according to claim 10, characterized in that the transmission path associated with the load-shifting clutch includes at least the transmission ratio step with the highest transmission ratio, and the load-shifting clutch is connectable with that transmission ratio step.

12. Transmission especially according to at least one of claims 5-11, characterized in that the transmission ratio steps of a transmission path and another transmission path can be shifted with reduced tractive force by activation of the associated clutches in shifting variation.

13. Transmission especially according to at least one of claims 5-12, characterized in that the transmission path associated with the starting clutch includes transmission ratio steps that are used for starting up.

14. Transmission especially according to at least one of claims 5-12, characterized in that the transmission path associated with the load-shifting clutch includes transmission ratio steps that are used for starting up.

15. Transmission especially according to claim 1 or 2-4, characterized in that one transmission path is associated with a clutch usable as load-shifting clutch as well as a starting clutch, and another transmission path is associated with no clutch.

16. Transmission according to claim 15, characterized in that the transmission path associated with no clutch includes at least two transmission ratio steps that are successive relative to their transmission ratios.

17. Transmission according to claim 15 or 16, characterized in that transmission ratio steps included in the transmission path associated with no clutch can be shifted with reduced tractive force interruption.

18. Transmission especially according to claim 17, characterized in that the transmission path associated with the clutch includes at least one transmission ratio step with a lower transmission ratio than that to be shifted with reduced tractive force interruption, and the clutch is connectable with that transmission ratio step.

19. Transmission especially according to claim 18, characterized in that the transmission path associated with the clutch includes at least the transmission ratio step with the lowest transmission ratio, and the clutch is connectable with that transmission ratio step.

20. Transmission especially according to claim 17, characterized in that the transmission path associated with the clutch includes at least one transmission ratio step with a higher transmission ratio than that to be shifted with reduced tractive force interruption, and the clutch is connectable with that transmission ratio step.

21. Transmission especially according to claim 20, characterized in that the transmission path associated with the clutch includes at least the transmission ratio step with the highest transmission ratio, and the clutch is connectable with that transmission ratio step.

22. Transmission especially in accordance with claim 15, characterized in that the transmission path associated with the clutch includes at least one starting transmission ratio step.

23. Transmission especially according to claim 5 or 15, characterized in that a transmission path includes at least one transmission ratio step that has approximately the same transmission ratio as a transmission ratio step included in another transmission path.

24. Transmission especially according to claim 5 or 15, characterized in that at least one transmission ratio step is selectively allocatable to one or another transmission path.

25. Transmission especially according to claim 24, characterized in that a transmission ratio step is arranged in the transmission in the end region of a hollow shaft surrounding a transmission shaft.

26. Transmission especially according to claim 25, characterized in that the transmission ratio step is selectively connectable with the hollow shaft or with the transmission shaft surrounded by it.

27. Transmission especially according to at least one of claims 23-26, characterized in that the transmission ratio step with the highest transmission ratio is present in one transmission path as well as in another transmission path, or is allocatable either to one transmission path or to another transmission path.

28. Transmission especially according to at least one of claims 23-26, characterized in that the transmission ratio step with the highest transmission ratio is present either in one transmission path or in another transmission path, or is allocatable either to one transmission path or another transmission path, and at least one further transmission ratio step with a lower transmission ratio is present in one transmission path as well as in another transmission path.

29. Transmission with an input shaft connectable with a drive motor, two transmission input shafts arranged coaxially one inside the other, a transmission output shaft, and at least one clutch, such as a friction clutch, whereby
whereby in the transmission at least a first and a second parallel transmission path are formed,
the first transmission path includes a plurality of transmission ratio steps shiftable with reduced tractive force and successive in relation to their transmission ratios, and is allocatable to a starting clutch or a combined starting/load-shifting clutch,
the second transmission path is associated with at least one load-shifting clutch or a combined starting/load-shifting clutch,
characterized in that the first transmission path is formed by the outer and the second transmission path by the inner of two coaxial transmission input shafts arranged one inside the other.

30. Transmission according to claim 1 or 29, characterized in that the starting and load-shifting clutches are formed with one separate clutch disk each.

31. Transmission according to claim 30, characterized in that the starting clutch lies in the power flow of the first, and the load-shifting clutch lies in the power flow of the second transmission path.

32. Transmission according to claim 30, characterized in that the starting clutch lies in the power flow of the first and the second transmission paths, and the load-shifting clutch lies in the power flow of the second transmission path.

33. Transmission according to claim 1, 29, characterized in that start up and load-shifting clutches are formed with a common clutch disk.

34. Transmission according to claim 33, characterized in that the clutch is selectively connectable with the first or with the second transmission path.

35. Transmission according to claim 33, characterized in that the first transmission path can be connected through the clutch or directly with the drive motor.

36. Method for operating a clutch, characterized in that increasing torque is transferred by engaging a clutch according to the engagement path.

37. Method for operating a clutch, characterized in that for ascertaining the contact point of the clutch
the transfer of torque at least up to the value of the contact torque is possible loss- or interruption-free in the transmission path associated with the load-shifting clutch between the drive motor and the load-shifting clutch,
the transfer of torque at least up to the value of the contact torque is possible loss- or interruption-free in the transmission path associated with the load-shifting clutch between the load-shifting clutch and the motor vehicle wheel,
the load-shifting clutch is not bypassed.

38. Method especially according to claim 36 or 37, characterized in that a transmission ratio step is engaged in the transmission path associated with the load-shifting clutch.

39. Method especially according to claim 36 or 37, characterized in that a vehicle brake associated with the driven vehicle wheels is actuated.

40. Method especially according to claim 36 or 37, characterized in that no transmission ratio step is engaged in the first transmission path.

41. Method especially according to claim 36 or 37, characterized in that if necessary a starting clutch associated with the transmission path of the load-shifting clutch is closed at least to the extent that a torque greater than the measuring torque is transferred.

42. Method especially according to one of claims 36 or 37-41, characterized in that the load-shifting clutch is engaged slowly until the contact point is reached.

43. Method especially according to claim 42, characterized in that the contact point is determined on the basis of decreasing rotational speed of the drive motor, and/or an increased output demand on the drive motor, and/or an increasing rotational speed in the region between the load-shifting clutch and the vehicle wheel, and/or on the basis of rising torque in the region between the drive motor and the load-shifting clutch and/or between the load-shifting clutch and the vehicle wheel.

44. Method especially according to one of claims 36 or 37-43, characterized in that the clutch position at the contact point is directly or indirectly stored.

45. Transmission with an input shaft connectable with a drive motor, an output shaft, and shafts lying in between through which a first and a second parallel transmission path is formed, whereby
the shafts carry gears that form transmission ratio steps since in each case a first gear wheel is non-rotatably connected as a speed change gear with a first shaft, and a second gear in engagement with the first gear is rotatably arranged on a second shaft as an idler gear, and the idler gear is connectable by means of a shifting clutch on the shaft on which it is carried,
the first transmission path includes a group of transmission ratio steps,
the second transmission path includes a group of transmission ratio steps,
the first and/or the second transmission path includes one or several starting transmission ratio steps,
a transmission path including a starting transmission ratio step is associated with a clutch, by means of which it is separable from the drive motor,
characterized in that a transmission ratio step is present in the first as well as in the second transmission path, or is effective in the first as well as in the second transmission path
the transmission ratio steps of the first transmission path, the transmission ratios of which are higher than those of the transmission ratio steps of the second transmission path, are connected with the load-shifting clutch, can be upshifted with reduced tractive force interruption,
the transmission ratio steps of the first transmission path, the transmission ratios of which are lower than those of the transmission ratio steps of the second transmission path, are connected with the load-shifting clutch, can be downshifted with reduced tractive force interruption.

46. Transmission especially according to claim 45, characterized in that the load-shifting clutch is fixedly connected with a transmission ratio step of the second transmission path.

47. Transmission especially according to claim 45, characterized in that the load-shifting clutch is selectively connectable with different transmission ratio steps of the second transmission path.
